(19) United States
(12) Patent Application Publication
(10) Pub. No.: US 2003/0097288 A1
(43) Pub. Date: May 22, 2003

(54) Inspection schedule management support system and inspection schedule management support method

(76) Inventors: Kiyoshi Shimomura, Tokyo (JP); Hiroki Murofushi, Hitachi (JP); Koichi Muramatsu, Hitachi (JP)

Correspondence Address: DICKSTEIN SHAPIRO MORIN & OSHINSKY LLP, 2101 L STREET NW, WASHINGTON, DC, 20037-1526, US

(21) Appl. No.: 10/265,775

(22) Filed: Oct. 8, 2002

(30) Foreign Application Priority Data
Nov. 5, 2001 (JP) 2001-339891

(51) Int. Cl. G06F 17/60

(52) U.S. Cl. 705/8

(57) ABSTRACT

To provide support for inspection schedule management of plant equipment so as to reduce the burden on preparation of the inspection schedule.

An inspection schedule management apparatus 1 creates inspection schedule data indicating an inspection schedule for power plant equipment or modifies the created inspection schedule data according to an instruction received from the operator at the user terminal 4 of a maintenance company through an input device or a LAN 5. The inspection schedule management apparatus 1 then prepares a Gantt chart based on the created or modified inspection schedule data, and sends it to the user terminal 4 of each linked company through a WAN 6 for indication.

### BACKGROUND OF THE INVENTION

The present invention relates to a technique suitable for supporting the management of an inspection schedule for plant equipment of a power plant, etc.

Inspection such as periodic inspection is indispensable to maintain plant equipment. Conventionally, the maintenance company for the plant equipment holds in-depth talks with the user (company) of the equipment and, based on the talks, fills in a form with the necessary information to prepare an inspection process schedule. The inspection is carried out according to the prepared inspection process schedule.

However, inspection of equipment for a large plant such as a power plant requires a number of inspection items to be employed, imposing a heavy burden on the preparation of the inspection process schedule.

On the other hand, the maintenance company for plant equipment generally uses fax or mail to send a prepared inspection process schedule to linked companies involved with the inspection of the plant equipment, such as the user (company), manpower dispatching companies (for supplying manpower for the inspection), and parts suppliers (for supplying parts necessary for the inspection). However, since a number of companies are involved with large plant equipment, some notifications may not reach all the companies due to human error.

Especially, when the inspection has fallen behind its schedule or an inspection item has been unexpectedly added (for example, as a result of parts replacement for some additional work), the schedule for the remaining subsequent inspection items must be modified. In this case, if the modification to the original inspection schedule does not reach all the linked companies, the subsequent inspection cannot be smoothly carried out.

The present invention has been devised in view of the above problems. It is, therefore, an object of the present invention to provide support for managing an inspection schedule for plant equipment so as to reduce the burden on the preparation of the inspection schedule. Another object of the present invention is to provide support for managing an inspection schedule for plant equipment so as to reduce the burden on issuance of a manpower dispatch notification or a parts order notification to linked companies in the management of the inspection schedule and the inspection itself.

### SUMMARY OF THE INVENTION

To solve the above problems, an inspection schedule management support system according to one aspect of the present invention for providing support for managing an inspection schedule for plant equipment comprises an inspection schedule database, a basic database, an inspection schedule display means, an instruction accepting means, and an inspection schedule preparation means.

The inspection schedule database stores inspection schedule data of the plant equipment including, for each device to be inspected, an estimated inspection start date, an estimated inspection end date, an inspection type (precise examination, ultrasonography, visual inspection, etc.), and the number of persons required for inspection.

The basic database stores one or more pieces of basic data including, for each device constituting the plant equipment, an inspection type and the number of days required for a predetermined persons to complete an inspection of the inspection type.

The inspection schedule display means causes a terminal (the terminal of each linked company, etc.) to display an inspection schedule of the plant equipment indicated by the inspection schedule data stored in the inspection schedule database, the terminal being connected to the inspection schedule display means through a network.

The instruction accepting means accepts an inspection schedule preparation instruction from an operator through an input device or a terminal (the terminal of the maintenance company for the plant equipment, etc.) connected to the instruction accepting means through a network, the inspection schedule preparation instruction including, for the plant equipment, an inspection start date, specification of each device to be inspected, an inspection sequence number of each specified device to be inspected, an inspection type of each specified device to be inspected, and the number of persons assigned to an inspection of the inspection type of each specified device to be inspected.

The inspection schedule preparation means calculates the estimated number of days required for the inspection of each device to be inspected based on the inspection type of each device to be inspected and the number of persons assigned to the inspection and basic data of each device to be inspected, and prepares inspection schedule data of the plant equipment based on a result of the above calculation and the inspection start date and the inspection sequence number of each device to be inspected for the plant equipment, wherein the inspection type, the number of persons, the inspection start date, and the inspection sequence number are included in the inspection schedule preparation instruction accepted by the instruction accepting means.

According to another aspect of the present invention, the instruction accepting means accepts from an operator an inspection schedule modification instruction including specification of a device to be inspected and a modification to an inspection type of the specified device to be inspected, wherein the inspection schedule preparation means recalculates the estimated number of days required for the inspection of the device to be inspected based on the modification included in the inspection schedule modification instruction (the estimated number of days also being included in the inspection schedule modification instruction), and modifies the inspection schedule data of the plant equipment stored in the inspection schedule database so as to change inspection schedule of devices whose inspection sequence number is larger than the inspection sequence number of the device to be inspected.

With the above configuration of the present invention, the operator only needs to specify the following items for plant equipment inspection: the inspection start date, each device to be inspected, the inspection sequence number of each device to be inspected, the inspection type of each device to be inspected, and the number of persons assigned to an inspection of the inspection type of each device to be inspected. Then, the system calculates the estimated number of days required for the inspection of each device to be inspected, prepares inspection schedule data of the plant equipment, stores it in the inspection schedule database, and causes a network terminal to display the inspection schedule data. This arrangement makes it possible to reduce the burden on persons responsible for preparing the inspection schedule and notifying each linked company of the inspection schedule.

According to still another aspect of the present invention, the inspection schedule management support system further comprises: manpower dispatch order request means for, for each device to be inspected indicated by the inspection schedule data of the plant equipment stored in the inspection schedule database, preparing a manpower dispatch order request for dispatching persons by an estimated inspection start date of the device to perform an inspection corresponding to an inspection type of the device, and transmitting the manpower dispatch order request to a predetermined terminal (the terminal of a manpower dispatching company, etc.) connected to the manpower dispatch order request means through a network; and a manpower dispatch order request database for storing the manpower dispatch order request for each device to be inspected indicated by the inspection schedule data of the plant equipment, the manpower dispatch order request being prepared by the manpower dispatch order request means.

In the above configuration, when the inspection schedule data of the plant equipment stored in the inspection schedule database has been modified, the manpower dispatch order request means may determine, for each device to be inspected indicated by the modified inspection schedule data, whether it is necessary to change contents of an order request, and if it is determined that it is necessary to change the contents, the manpower dispatch order request means may prepare an order contents change request for the manpower dispatch order request and transmit it to the predetermined terminal.

This arrangement makes it possible to reduce the burden on persons responsible for issuing the manpower dispatch order request or changing it, which is necessary to carry out inspection according to prepared or changed inspection schedule data.

According to yet another aspect of the present invention, the inspection schedule management support system is configured such that: when (inspection for) part replacement is required as inspection type, the basic data includes identification information on a replacement part; and for each device to be inspected, when (inspection for) part replacement is required as an inspection type, said inspection schedule data includes identification information on a replacement part; wherein the inspection schedule management support system further comprises: parts order request means for, for each device to be inspected indicated by the inspection schedule data of the plant equipment stored in the inspection schedule database, when (inspection for) part replacement is required as an inspection type of the device, preparing a parts order request for supplying a part specified by the identification information by an estimated inspection start date of the device, and transmitting the parts order request to a predetermined terminal (the terminal of a parts supplier, etc.) connected to the parts order request means through a network; and a parts order request database for storing the parts order request for each device to be inspected indicated by the inspection schedule data of the plant equipment, the parts order request being prepared by the parts order request means.

In the above configuration, when the inspection schedule data of the plant equipment stored in the inspection schedule database has been modified, the parts order request means may determine, for each device to be inspected indicated by the modified inspection schedule data, whether it is necessary to change contents of an order request in the case where the inspection type of the device is “part replacement”, and if it is determined that it is necessary to change the contents, the parts order request means may prepare an order contents change request for the parts order request and transmit it to the predetermined terminal.

This arrangement makes it possible to reduce the burden on persons responsible for issuing the parts order request or changing it, which is necessary to carry out inspection according to prepared or changed inspection schedule data.

### BRIEF DESCRIPTION OF THE DRAWINGS

Other objects and advantages of the invention will become apparent from the following description of embodiments with reference to the accompanying drawings in which:

FIG. 1 is a schematic diagram showing an inspection schedule management support system for power plant equipment according to an embodiment of the present invention;

FIG. 2 is a block diagram showing the function of the inspection schedule management apparatus 1 shown in FIG. 1;

FIG. 3 is a diagram showing an example of what is registered in the inspection schedule DB 106 shown in FIG. 2;

FIG. 4 is a diagram showing an example of what is registered in the basic information DB 107 shown in FIG. 2;

FIG. 5 is a diagram showing a hardware configuration of the inspection schedule management apparatus 1 shown in FIG. 2;

FIG. 6 is a flowchart illustrating the operation of the inspection schedule management apparatus 1 shown in FIG. 2;

FIG. 7 is a diagram showing a display target selection screen which the inspection schedule management apparatus 1 causes a user terminal 4 to display;

FIG. 8 is a diagram showing a Gantt chart screen which the inspection schedule management apparatus 1 causes a user terminal 4 to display;

FIG. 9 is a diagram showing another Gantt chart screen which the inspection schedule management apparatus 1 causes a user terminal 4 to display;

FIG. 10 is a diagram showing a menu screen which the inspection schedule management apparatus 1 causes a user terminal 4 to display;

FIG. 11 is a diagram showing an inspection schedule preparation instruction acceptance screen which the inspection schedule management apparatus 1 causes a user terminal 4 to display;

FIG. 12 is a diagram showing another inspection schedule preparation instruction acceptance screen which the inspection schedule management apparatus 1 causes a user terminal 4 to display;

FIG. 13 is a diagram showing still another inspection schedule preparation instruction acceptance screen which the inspection schedule management apparatus 1 causes a user terminal 4 to display;

FIG. 14 is a diagram showing an inspection schedule modification instruction acceptance screen which the inspection schedule management apparatus 1 causes a user terminal 4 to display;

FIG. 15 is a diagram showing still another inspection schedule modification instruction acceptance screen which the inspection schedule management apparatus 1 causes a user terminal 4 to display;

FIG. 16 is a block diagram showing the function of the manpower dispatch ordering apparatus 2 shown in FIG. 1;

FIG. 17 is a diagram showing an example of what is registered in the manpower dispatching company DB 204 shown in FIG. 16;

FIG. 18 is a diagram showing an example of what is registered in the order information DB 205 shown in FIG. 16;

FIG. 19 is a flowchart illustrating the operation of the manpower dispatch ordering apparatus 2 shown in FIG. 16;

FIG. 20 is a block diagram showing the function of the parts ordering apparatus 3 shown in FIG. 1;

FIG. 21 is a diagram showing an example of what is registered in the parts supplier DB 304 shown in FIG. 20;

FIG. 22 is a diagram showing an example of what is registered in the order information DB 305 shown in FIG. 20.

FIG. 23 is a flowchart illustrating the operation of the parts ordering apparatus 3 shown in FIG. 20; and

FIG. 24 is a schematic system diagram showing a variation of the inspection schedule management support system for power plant equipment shown in FIG. 1, wherein the maintenance company has a parts producing department and a manpower dispatching department.

### DESCRIPTION OF THE PREFERRED EMBODIMENTS

A preferred embodiment of the present invention will be described below.

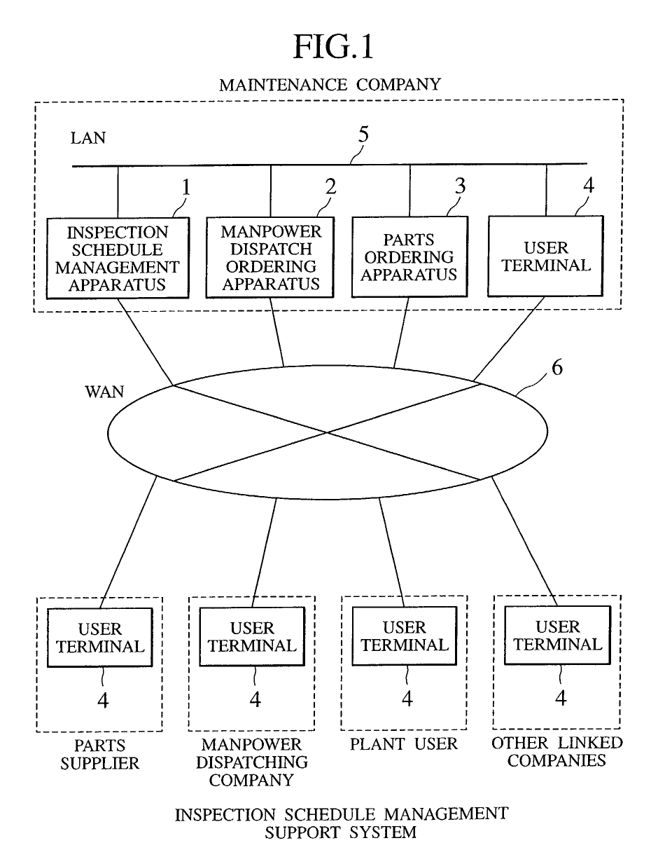

FIG. 1 is a schematic diagram showing an inspection schedule management support system for power plant equipment according to an embodiment of the present invention.

A user terminal 4 is a network terminal capable of transmitting information to other devices or receiving information from them to display it through a WAN 6 (represented by the Internet, etc.). A user terminal 4 is installed in a facility of each company involved with the inspection of the power plant equipment, such as the maintenance company, the power plant user (company), a parts supplier, or a manpower dispatching company.

The facilities of the maintenance company include, in addition to the user terminal 4, an inspection schedule management apparatus 1, a manpower dispatch ordering apparatus 2, and a parts ordering apparatus 3, which are each connected to the user terminal 4 of each linked company through the WAN 6. These apparatuses are connected to one another by way of a LAN 5 installed in the facilities of the maintenance company. The user terminal 4 of the maintenance company is configured such that it can transmit information to the inspection schedule management apparatus 1, the manpower dispatch ordering apparatus 2, and the parts ordering apparatus 3 and receive information from them for indication.

In the above configuration, the inspection schedule management apparatus 1 creates inspection schedule data indicating an inspection schedule for power plant equipment or modifies the created inspection schedule data according to an instruction received from the operator (of the maintenance company) at the user terminal 4 of the maintenance company through the LAN 5 or an input device. The inspection schedule management apparatus 1 then prepares a Gantt chart based on the created or modified inspection schedule data and sends it to the user terminal 4 of each linked company through the WAN 6.

When the inspection schedule management apparatus 1 has newly created inspection schedule data, the manpower dispatch ordering apparatus 2 prepares, for each device to be inspected included in the power plant equipment indicated by the inspection schedule data, a manpower dispatch order request for dispatching manpower necessary for inspection by an estimated inspection start date, and transmits the prepared manpower dispatch order request to the user terminal 4 of a manpower dispatching company through the WAN 6. When the inspection schedule management apparatus 1 has modified created inspection schedule data, on the other hand, the manpower dispatch ordering apparatus 2 determines, for each device to be inspected indicated by the modified inspection schedule data, whether it is necessary to change the contents of a manpower dispatch order request, and if it is determined that the contents must be changed, the manpower dispatch ordering apparatus 2 prepares an order contents change request for the manpower dispatch order request and transmits it to the user terminal 4 of the manpower dispatching company through the WAN 6.

As for the parts ordering apparatus 3, when the inspection schedule management apparatus 1 has newly created inspection schedule data, the parts ordering apparatus 3 prepares, for each device to be inspected included in the power plant equipment indicated by the inspection schedule data, a parts order request for supplying a part (for example, a replacement part) necessary for inspection by an estimated inspection start date and transmits it to the user terminal 4 of a parts supplier through the WAN 6. When the inspection schedule management apparatus 1 has modified created inspection schedule data, on the other hand, the parts ordering apparatus 3 determines, for each device to be inspected indicated by the modified inspection schedule data, whether it is necessary to change the contents of the parts order request, and if it is determined that the contents must be changed, the parts ordering apparatus 3 prepares an order contents change request for the parts order request and transmits it to the user terminal 4 of the parts supplier through the WAN 6.

The inspection schedule management apparatus 1, the manpower dispatch ordering apparatus 2, and the parts ordering apparatus 3 will be described in further detail below.

It should be noted that the user terminal 4 may be a general computer system provided with an information browsing function using a Web browser, etc., an information exchange function such as electronic mail, and an information transmission function using CGI (Common Gateway Interface). Since the user terminal 4 can be implemented as described above, its detailed description will be omitted.

First of all, the inspection schedule management apparatus 1 will be described.

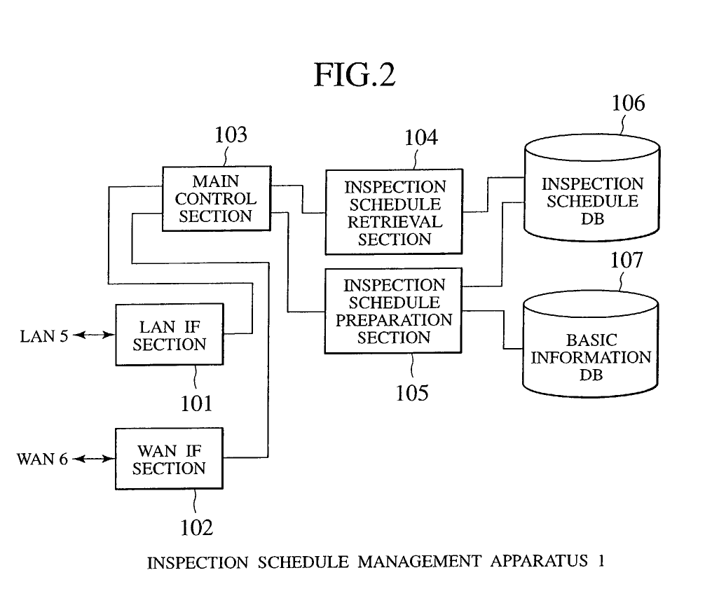

FIG. 2 is a block diagram showing the function of the inspection schedule management apparatus 1.

The inspection schedule management apparatus 1 comprises a LAN IF (interface) section 101 for communications through the LAN 5, a WAN IF section 102 for communications through the WAN 6, a main control section 103, an inspection schedule retrieval section 104, an inspection schedule preparation section 105, an inspection schedule DB (database) 106, and a basic information DB 107.

The main control section 103 is provided with, for example, an information publishing function using a Web server, etc. and an information retrieval function using CGI, etc., and accepts various instructions from other apparatuses through the LAN IF section 101 and the WAN IF section 102. The main control section 103 then controls the inspection schedule retrieval section 104 and the inspection schedule preparation section 105 to perform processing according to the accepted instructions.

The inspection schedule retrieval section 104 creates a list of inspection schedule data stored in the inspection schedule DB 106 or retrieves specified inspection schedule data from the inspection schedule DB 106 according to an instruction from the main control section 103.

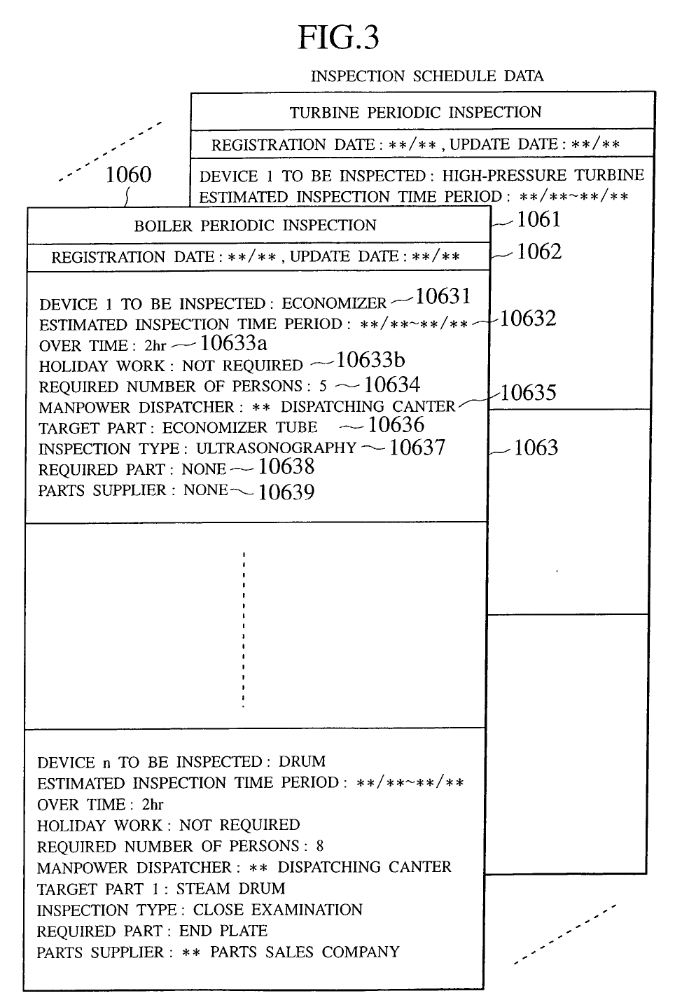

FIG. 3 is a diagram illustrating an example of what is registered in the inspection schedule DB 106.

As shown in the figure, each piece of inspection schedule data 106 stored in the inspection schedule DB 106 is composed of inspection schedule identification data 1061 (for example, a title), registration/update date data 1062, and one or more pieces of inspection item data 1063 arranged according to the inspection schedule.

Each piece of inspection item data 1063 includes information necessary for specifying an inspection item. Specifically, each piece of inspection item data 1063 includes: “device to be inspected” (parameter or field) 10631 for holding identification data of a device to be inspected, such as a device title; “estimated inspection time period” 10632; “per-day over time” 10633a; “whether holiday work is required” 10633b; “required number of persons” 10634 for holding the number of persons required for inspection; “manpower dispatcher” 10635 for holding identification data (for example, a company name) of a manpower dispatching company which supplies the required number of persons; “part to be inspected” or “target part” 10636 for holding identification data of a part to be inspected included in the device to be inspected; “inspection type” 10637 for indicating the type of inspection to be carried out for the part to be inspected; “required part” 10638 for holding identification data (for example, a part name) of a part to be prepared for inspection (if “inspection type” indicates “parts replacement”, the part to be prepared is set to be the part to be inspected); and “parts supplier” 10639 for holding identification data (for example, a supplier name) of a parts supplier which supplies the part to be prepared.

It should be noted that the main control section 103 prepares a Gantt chart based on inspection schedule data 1060 read out from the inspection schedule DB 106 by the inspection schedule retrieval section 104. The main control section 103 then sends the prepared Gantt chart to each user terminal 4 through the LAN IF section 101 or the WAN IF section 102.

The inspection schedule preparation section 105 creates a list of basic data stored in the basic information DB 107 according to an instruction from the main control section 103. The inspection schedule preparation section 105 also creates inspection schedule data 1060 as shown in FIG. 3 based on an inspection schedule preparation instruction which is received from the main control section 103 and which includes identification data of an inspection schedule, the inspection start date of the inspection schedule, specification of each piece of basic data, the inspection sequence number of each of piece of specified basic data, and the number of persons required for the inspection indicated by each piece of specified basic data. The inspection schedule preparation section 105 stores the created inspection schedule data 1060 in the inspection schedule DB 106. Based on an inspection schedule modification instruction which is received from the main control section 103 and which includes inspection schedule identification data, specification of basic data, and the number of persons required for the inspection indicated by the specified basic data, the inspection schedule preparation section 105 modifies inspection schedule data 1060 having the above inspection schedule identification data and stored in the inspection schedule DB 106.

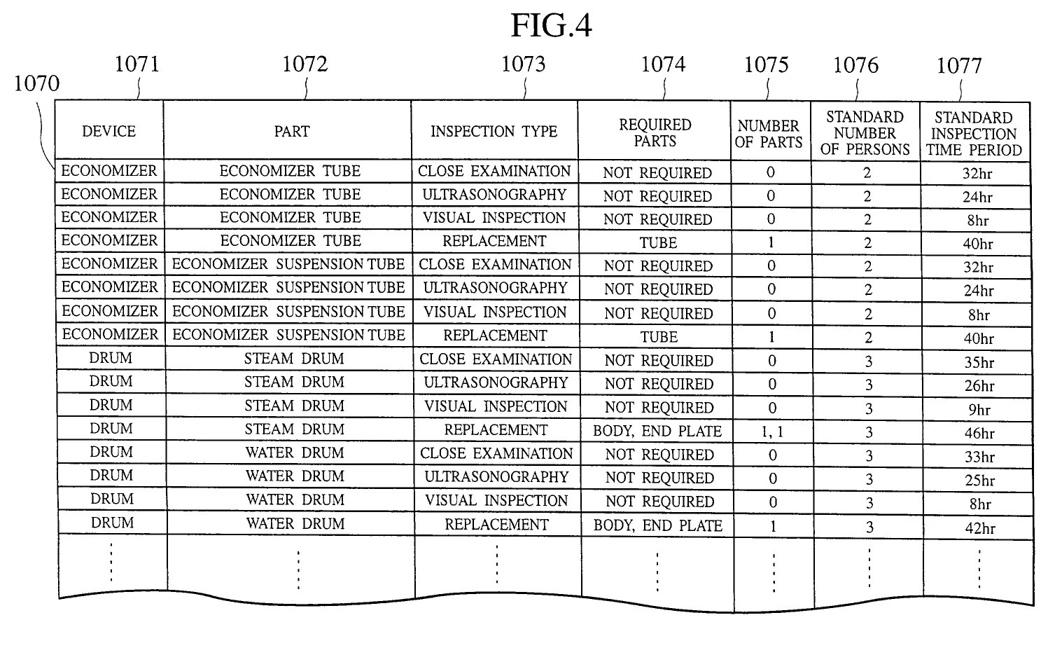

FIG. 4 is a diagram showing an example of what is registered in the basic information DB 107.

As shown in the figure, each record 1070 included in the basic data includes: field 1071 for holding identification data of an device; field 1072 for holding identification data of a part; field 1073 for holding an inspection type; field 1074 for holding identification data of each part type required for an inspection of the inspection type (required parts); field 1075 for holding the number of parts for each required part type (number of parts); field 1076 for holding the number of persons generally required for the above inspection of the inspection type (standard number of persons); and field 1077 for storing the inspection time period generally required for the standard number of persons to complete the above inspection of the inspection type (standard inspection time period).

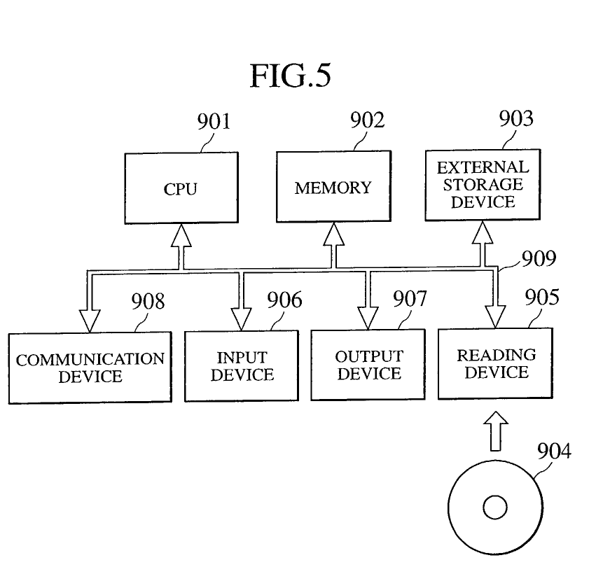

The above inspection schedule management apparatus 1 can be implemented on a computer system having a general configuration (for example, one shown in FIG. 5) comprising: a CPU 901; a memory 902; an external storage device 903 (a hard disk device, etc.); a reading device 905 for reading data from a portable storage medium 904 (a CD-ROM, a DVD-ROM, etc.); an input device 906 (a mouse, a keyboard, etc.); an output device 907 (a CRT, an LCD, etc.); a communication device 908 for performing communications through the LAN 5 and the WAN 6; and a bus 909 for connecting these devices. With this configuration, a program for implementing each functional block of the inspection schedule management apparatus 1 on a computer may be loaded into the memory 902 from the external storage device 903, or from the storage medium 904 through the reading device 905. Or alternatively, the program may be loaded into the memory 902 from the LAN 5 or the WAN 6 through the communication device 908. In the above case, the external storage device 903 may be used for (storing) the inspection schedule DB 106 and the basic information DB 107.

Description will be made below of the operation of the inspection schedule management apparatus 1 having the above configuration.

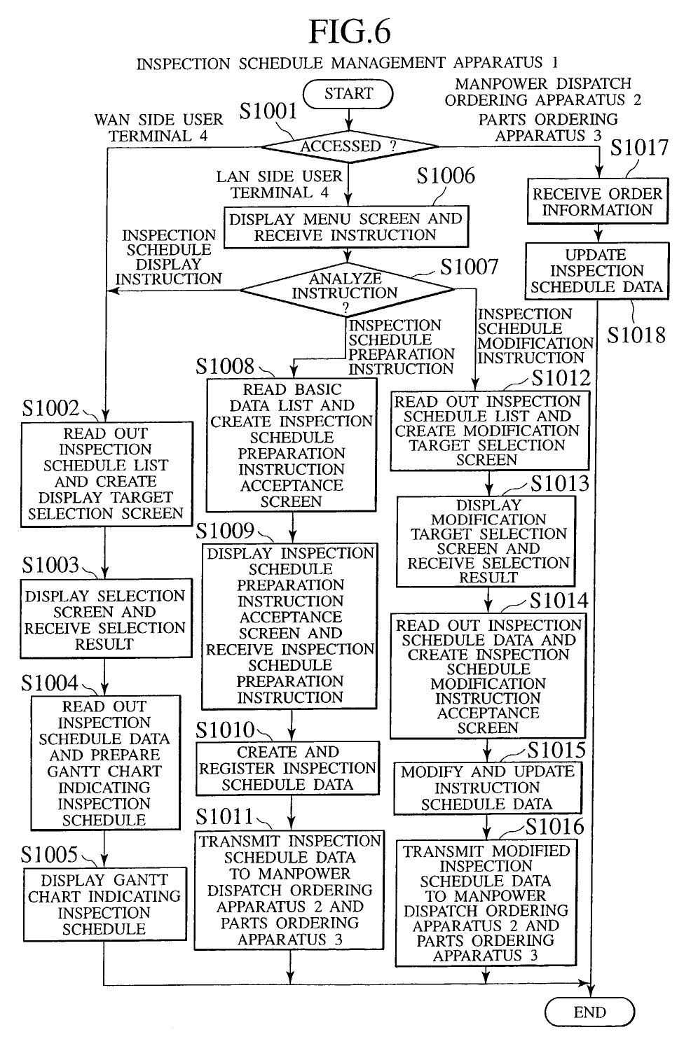

FIG. 6 is a flowchart illustrating the operation of the inspection schedule management apparatus 1.

Upon being accessed by another device through the LAN IF section 101 or the WAN IF section 102, the main control section 103 performs authentication processing on the accessing device to identify it at step S1001. If the accessing device is the user terminal 4 of a linked company other than the maintenance company (a user terminal 4 on the WAN 6 side), the processing flow proceeds to step S1002. If it is the user terminal 4 of the maintenance company (the user terminal 4 on the LAN 5 side), on the other hand, the processing flow proceeds to step S1006. If the accessing device is either the manpower dispatch ordering apparatus 2 or the parts ordering apparatus 3, the processing flow proceeds to step S1017.

At step S1002, the main control section 103 instructs the inspection schedule retrieval section 104 to create an inspection schedule list. Upon receiving the instruction, the inspection schedule retrieval section 104 reads out all inspection schedule identification data 1061 stored in the inspection schedule DB 106, and inputs the read identification data 1061 to the main control section 103. Based on the inspection schedule identification data 106 received from the inspection schedule retrieval section 104, the main control section 103 creates data of a display target selection screen on which a user terminal 4 on the WAN 6 side can select an inspection schedule to be displayed. The main control section 103 then causes the user terminal 4 on the WAN 6 side to display the display target selection screen through the WAN IF section 102 so that the main control section 103 can receive specification of an inspection schedule to be displayed from the operator at the user terminal 4 on the WAN 6 side at step 1003.

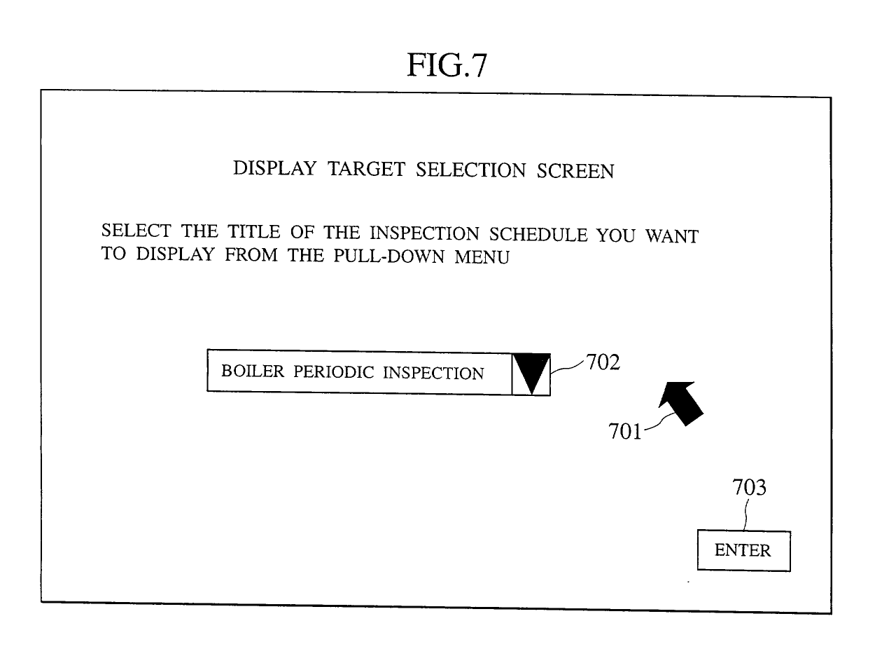

FIG. 7 is a diagram showing an example of the display target selection screen. The operator at the user terminal 4 can move a cursor 701 by use of an input device such as a mouse to select desired inspection schedule identification data 1061 (title name) from among the list of inspection schedule identification data 1061 in the pull-down menu 702. The operator can then push an enter button 703 to transmit the desired inspection schedule identification data 1061 to the inspection schedule management apparatus 1.

At step S1004, upon receiving the inspection schedule identification data 1061 from the user terminal 4 on the WAN side through the WAN IF section 102, the main control section 103 inputs the identification data to the inspection schedule retrieval section 104 and instructs the inspection schedule retrieval section 104 to read out the (corresponding) inspection schedule data 1060. In response, the inspection schedule retrieval section 104 reads out the inspection schedule data 1060 having the same inspection schedule identification data as that entered by the main control section 103 from the inspection schedule DB 106, and inputs the read inspection schedule data 1060 to the main control section 103. The main control section 103 creates data of a Gantt chart screen indicating the inspection schedule based on the “estimated inspection time period” 10632 of each piece of inspection item data 1063 included in the inspection schedule data 1060 received from the inspection schedule retrieval section 104. Then, the main control section 103 causes the user terminal 4 on the WAN 6 side to display the Gantt chart screen through WAN IF section 102 at step S1005.

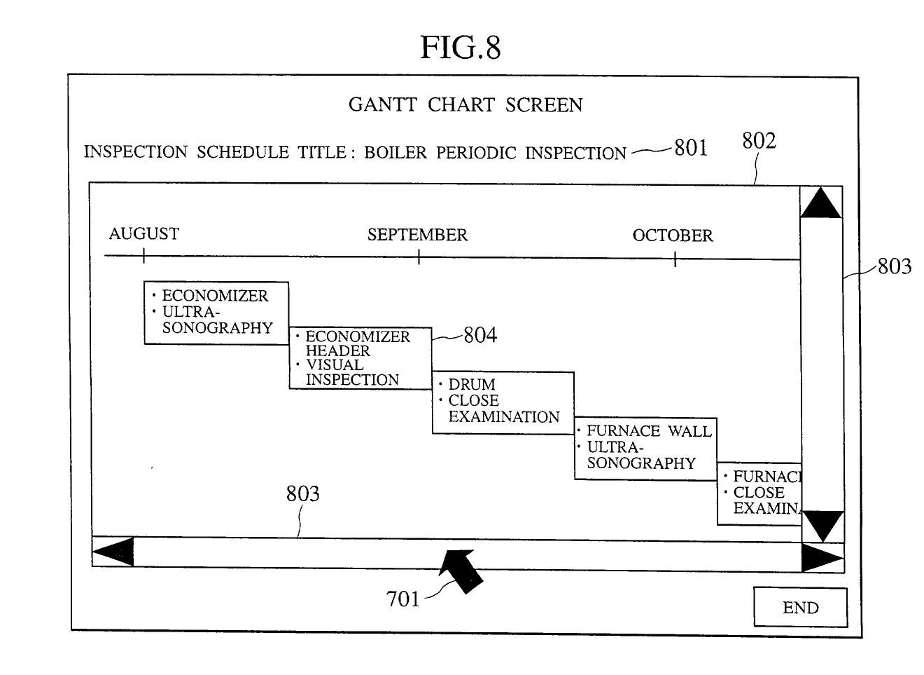

FIG. 8 is a diagram showing an example of the Gantt chart screen. In the figure, reference numeral 801 denotes the title name indicated by inspection schedule identification data 1061, and 802 denotes the display frame of the Gantt chart produced based on the inspection schedule data 1060. In the example shown in FIG. 8, scrollbars 803 are provided to scroll the Gantt chart displayed within the display frame 802 vertically and horizontally. The operator at the user terminal 4 can move the scrollbars 803 with the cursor 701 to scroll the Gantt chart displayed within the display frame 802 vertically and horizontally.

Each frame denoted by reference numeral 804 corresponds to a piece of inspection item data 1063 and, in this example, displays the identification data (“device to be inspected”) 10631 of a device to be inspected and its “inspection type” 10637 therein. Each frame 804 is linked to respective inspection item data 1063 so that if the operator at the user terminal 4 selects a desired frame 804 with the cursor 701, the inspection item data 1063 corresponding to the frame 804 is displayed in a list 805.

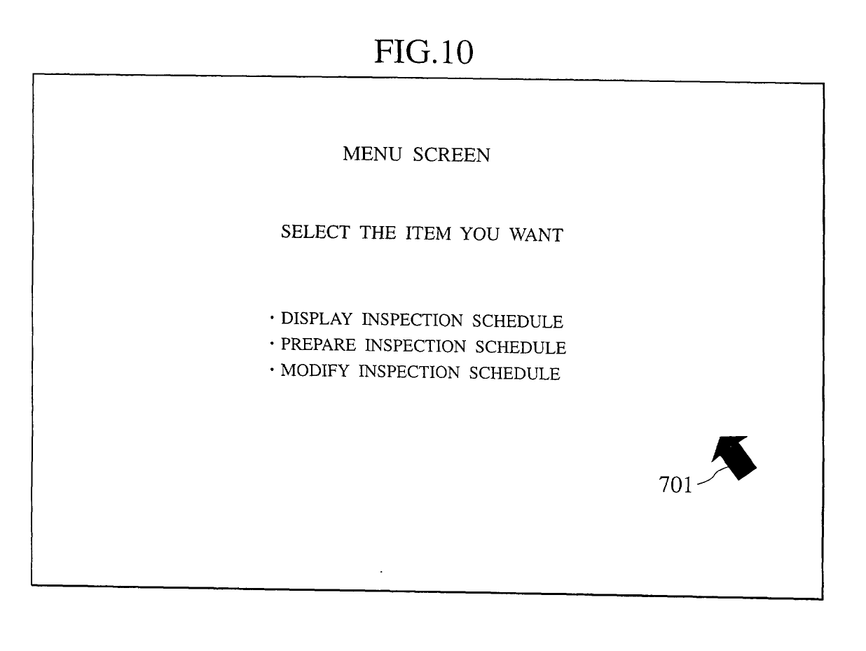

On the other hand, at step S1006, the main control section 103 causes the user terminal 4 on the LAN 5 side to display a menu screen as shown in FIG. 10 through the LAN IF section 101 so that the main control section 103 can accept an instruction from the operator at the user terminal 4 on the LAN 5 side. At step S1007, the main control section 103 analyses the received instruction. If it is an inspection schedule preparation instruction, the processing flow proceeds to step S1008. If it is an inspection schedule modification instruction, the processing flow proceeds to step S1012. Furthermore, if the received instruction is an inspection schedule display instruction, the main control section 103 performs the above processing at steps S1002 to S1005 for user terminal 4 on the LAN 5 side.

Upon receiving an inspection schedule preparation instruction from the user terminal 4 on the LAN 5 side at step S1007, the main control section 103 proceeds to step S1008, as described above, where the main control section 103 instructs the inspection schedule preparation section 105 to create a basic data list. In response, the inspection schedule preparation section 105 reads out all records 1070 of basic data stored in the basic information DB 107 and inputs the read records 1070 to the main control section 103. Based on the records 1070 of basic data received from the inspection schedule preparation section 105, the main control section 103 creates data of an inspection schedule preparation instruction acceptance screen for accepting from the user terminal 4 on the LAN 5 side an inspection schedule preparation instruction including information necessary to create inspection schedule data (also at step S1008). The main control section 103 then causes the user terminal 4 on the LAN 5 side to display the inspection schedule preparation instruction acceptance screen through the LAN IF section 101 so that the main control section 103 can accept an inspection schedule preparation instruction from the user terminal 4 on the LAN 5 side at step S1009. After that, the main control section 103 causes the inspection schedule preparation section 105 to create inspection schedule data 1060 based on the accepted inspection schedule preparation instruction and store it in the inspection schedule DB 106 at step 1010.

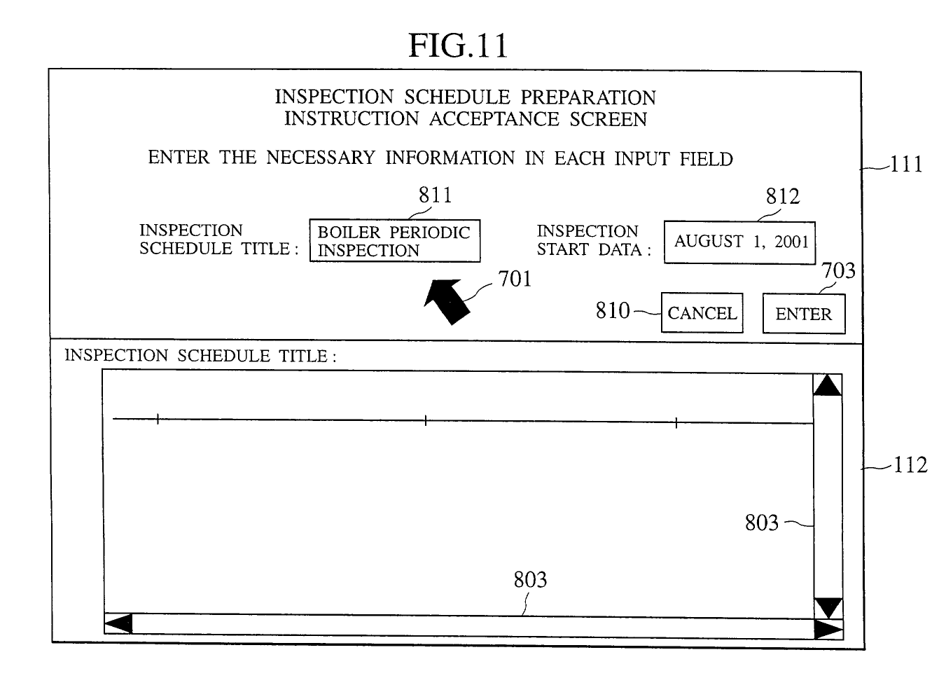

FIGS. 11 to 13 are diagrams each showing an example of the inspection schedule preparation instruction acceptance screen. As shown in the figures, the inspection schedule preparation instruction acceptance screen is made up of: a child screen 111 for accepting information necessary for preparing an inspection schedule; and a child screen 112 for displaying the inspection schedule as it is being prepared based on the received information. FIG. 11 shows an initially displayed inspection schedule preparation instruction acceptance screen in which the child screen 111 includes an input field 811 for accepting inspection schedule identification data (a title name) 1061 and an input field 812 for accepting an inspection start date.

On the inspection schedule preparation instruction acceptance screen shown in FIG. 11, when the operator at the user terminal 4 on the LAN 5 side has entered information into the input fields 811 and 812 using the cursor 701 and an input device such as a keyboard and selected an enter button 703, inspection schedule identification data 1061 and data of an inspection start date are transmitted from the user terminal 4 on the LAN 5 side to the inspection schedule management apparatus 1.

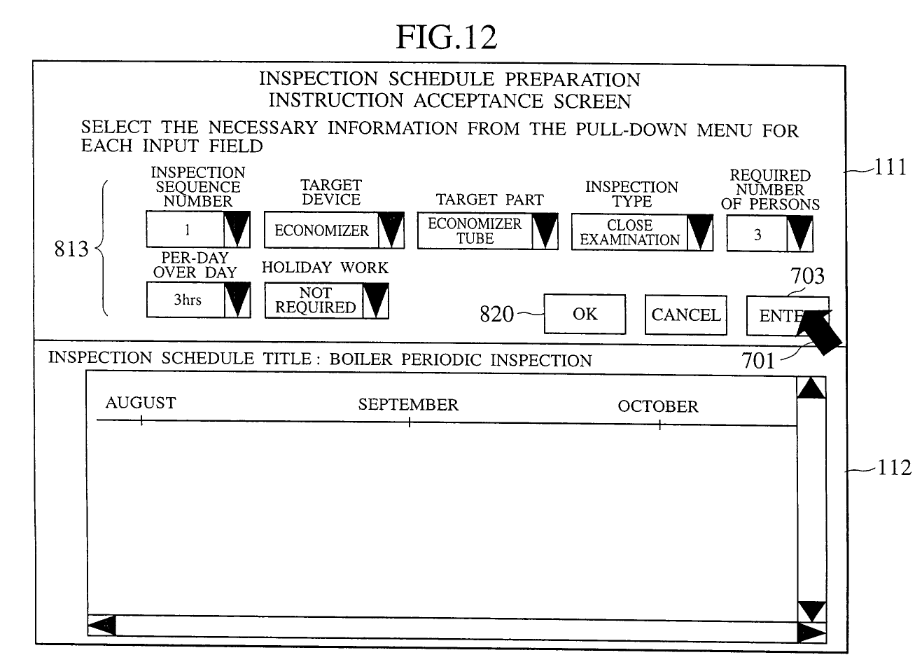

Upon receiving these data through the LAN IF section 101 and the main control section 103, the inspection schedule preparation section 105 creates a calendar starting from the inspection start date or a date a little earlier than the inspection start date. The inspection schedule preparation section 105 then inputs the calendar and the inspection schedule identification data 1061 to the main control section 103. In response, the main control section 103 creates display data including the calendar and the inspection schedule identification data 1061 and updates the display contents of the child screen 112 by the created display data, as shown in FIG. 12. The main control section 103 also updates the display contents of the child screen 111 so as to display a group of input fields 813 for accepting information necessary to specify an inspection item constituting the inspection schedule; specifically, the information (hereinafter referred to as inspection item specification information) includes the inspection sequence number in the inspection schedule, information (such as “target device” 10631 and “target part” 10636 and “inspection type” 10637) necessary to specify basic data 1070 which forms a base for creating the (corresponding) inspection item data 1063, and information (such as “required number of persons” 10634, “per-day over time” 10633a, and “whether holiday work is required” 10633b) necessary to calculate the estimated number of days required for the inspection.

On the inspection schedule preparation instruction acceptance screen shown in FIG. 12, when the operator at the user terminal 4 on the LAN 5 side has selected the enter button 703 using the cursor 701 and an input device such as a keyboard, the inspection item specification information held in the group of input fields 813 is transmitted from the user terminal 4 on the LAN 5 side to the inspection schedule management apparatus 1.

Upon receiving the inspection item specification information through the LAN IF section 101 and the main control section 103, the inspection schedule preparation section 105 prepares a schedule for the inspection item using the inspection item specification information. Specifically, the inspection schedule preparation section 105 reads from the basic information DB 107 a record 1070 of basic data whose fields 1071, 1072, and 1073 contain the same entries as those indicated by “target device” 10631, “target part” 10636, and “inspection type” 10637, respectively, included in the inspection item specification information.

The inspection schedule preparation section 105 then calculates the estimated number of days to be required for the inspection by use of the standard number of persons and the standard inspection time period held in the fields 1076 and 1077, respectively, of the record and “required number of persons” 10634 and “per-day over time” 10633a included in the inspection item specification information. The estimated number of days required for the inspection is obtained by the following formula: estimated number of days required for inspection=(standard number of persons×standard inspection time period÷required number of persons)÷(standard working hours (for example, 8 hours)+per-day over time).

Then, as the inspection start date of the target inspection item, the inspection schedule preparation section 105 sets the day next to the estimated inspection end date of the inspection item having an inspection sequence number one smaller than that of the target inspection item included in the inspection item specification information (or if the inspection item specification information includes the first inspection item, the inspection start date entered in the input field 812 shown in FIG. 11 is set to be the inspection start date of the target inspection item). The inspection schedule preparation section 105 then calculates the estimated number of days required for the inspection and assigns it to the calendar to determine “estimated inspection time period” 10632 of the target inspection item. At that time, if “whether holiday work is required” 10633b indicates “required”, some of the estimated number of days required for the inspection are assigned to the holidays when determining “estimated inspection time period” 10632 of the target inspection item.

After thus determining “estimated inspection time period” 10632 of the target inspection item, the inspection schedule preparation section 105 creates inspection item data 1063 including the determined “estimated inspection time period” 10632, and “target device” 10631, “target part” 10636, “inspection type” 10637, “required number of persons” 10634, “per-day over time” 10633a, and “whether holiday work is required” 10633b all included in the inspection item specification information, and sets the created inspection item data 1063 as the inspection item data 1063 of the target inspection item (whose inspection sequence number is included in the inspection item specification information). The inspection schedule preparation section 105 then inputs the inspection item data 1063 to the main control section 103. Upon receiving the inspection item data 1063, the main control section 103 creates display data for displaying a calendar having arranged therein each inspection item indicated by the above inspection item data 1063 and the inspection item data 1063 received so far from the inspection schedule preparation section 105. The main control section 103 then updates the display contents of the child screen 112 by the created display data and clears the group of input fields 813 in the child screen 111 so that inspection item specification information can be newly accepted.

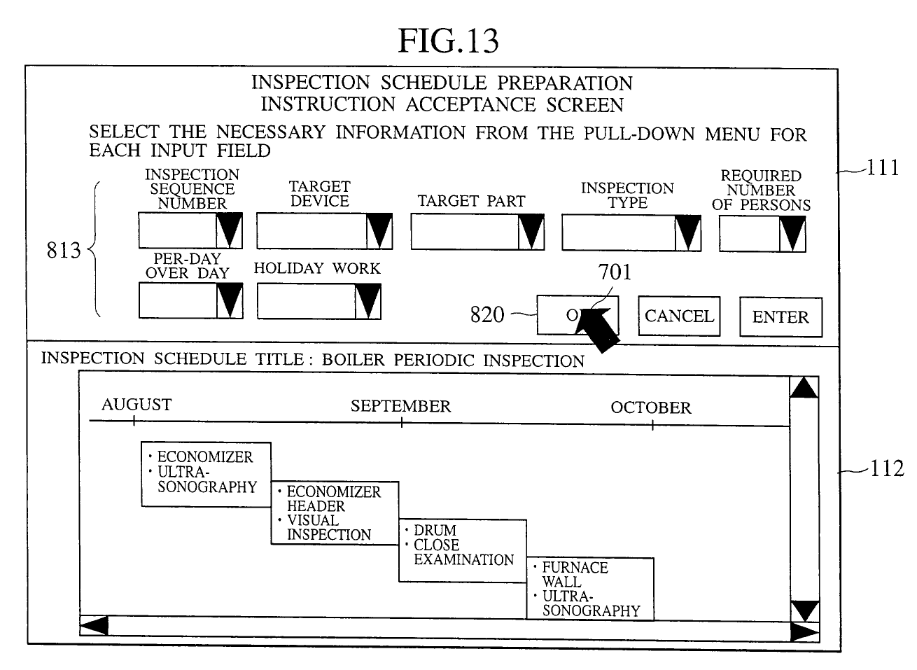

Repeating the above process creates the inspection schedule in the child screen 112 on the inspection schedule preparation instruction acceptance screen shown in FIG. 13 one inspection item at a time. Then, if the operator at the user terminal 4 on the LAN 5 side selects an enter button 820 using the cursor 701 and an input device such as a keyboard, a termination instruction is transmitted from the LAN 5 side to the inspection schedule management apparatus 1. Upon receiving the termination instruction, the main control section 103 controls the inspection schedule preparation section 105 so as to create inspection schedule data 1060 including the inspection schedule identification data 1061 and the inspection item data 1063 created so far and store it in the inspection schedule DB 106.

After the inspection schedule preparation section 105 creates the inspection schedule data 1060, the main control section 103 transmits it to the manpower dispatch ordering apparatus 2 and the parts ordering apparatus 3 through the LAN IF section 101 at step S1011.

On the other hand, upon receiving an inspection schedule modification instruction from the user terminal 4 on the LAN 5 side, the main control section 103 proceeds to step S1012, as described above, where the main control section 103 instructs the inspection schedule retrieval section 104 to make a list of inspection schedules. Receiving the instruction, the inspection schedule retrieval section 104 reads out all inspection schedule identification data 1061 stored in the inspection schedule DB 106, and inputs it to the main control section 103. Based on the inspection schedule identification data 1061 received from the inspection schedule retrieval section 104, the main control section 103 creates data of a modification target selection screen on which the user terminal 4 on the LAN 5 side can select an inspection schedule to be modified. The main control section 103 then causes the user terminal 4 on the LAN 5 side to display the modification target selection screen through the LAN IF section 101 so that the main control section 103 can accept specification of the inspection schedule to be modified at step S1013. It should be noted that the modification target selection screen may be similar to the display target selection screen shown in FIG. 7.

Upon receiving inspection schedule identification data 1061 from the user terminal 4 on the LAN 5 side through the LAN IF section 101, the main control section 103 inputs it to the inspection schedule retrieval section 104 and instructs the inspection schedule retrieval section 104 to read out the (corresponding) inspection schedule data 1060. In response, the inspection schedule retrieval section 104 reads out the inspection schedule data 1060 having the same inspection schedule identification data as that entered by the main control section 103 from the inspection schedule DB 106, and inputs the read inspection schedule data 1060 to the main control section 103.

Based on the inspection schedule data 1060 received from the inspection schedule retrieval section 104, the main control section 103 creates data of an inspection schedule modification instruction acceptance screen for accepting from the user terminal 4 on the LAN 5 side an inspection schedule modification instruction including information necessary to modify the inspection schedule data. The main control section 103 then causes the user terminal 4 on the LAN 5 side to display the inspection schedule modification instruction acceptance screen through the LAN IF section 101 so that the main control section 103 can accept an inspection schedule modification instruction from the operator at the user terminal 4 on the LAN 5 side. After that, the main control section 103 causes the inspection schedule preparation section 105 to modify the inspection schedule data 1060 stored in the inspection schedule DB 106 and read out by the inspection schedule retrieval section 104 according to the accepted inspection schedule modification instruction, at step S1015.

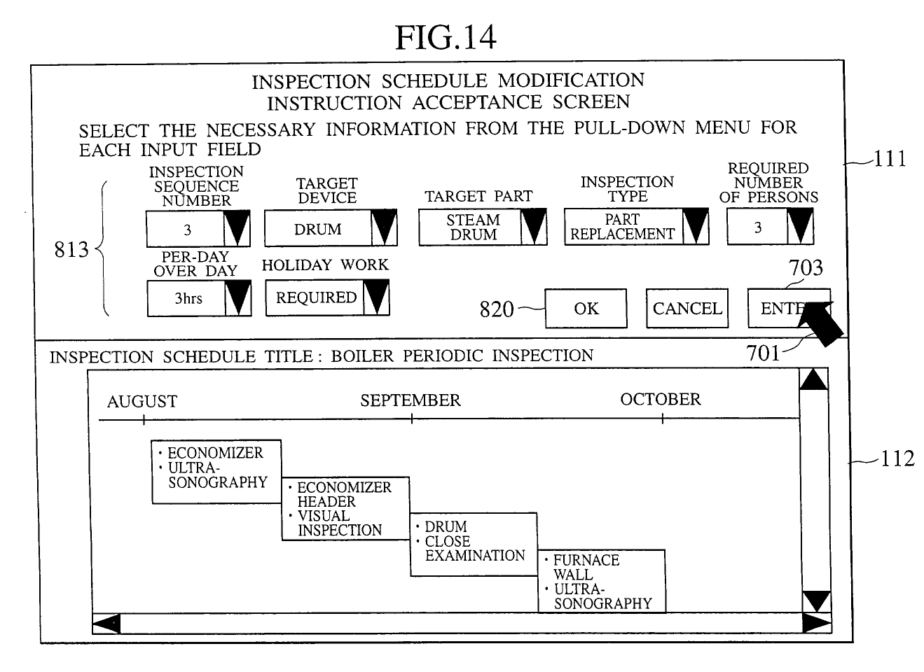

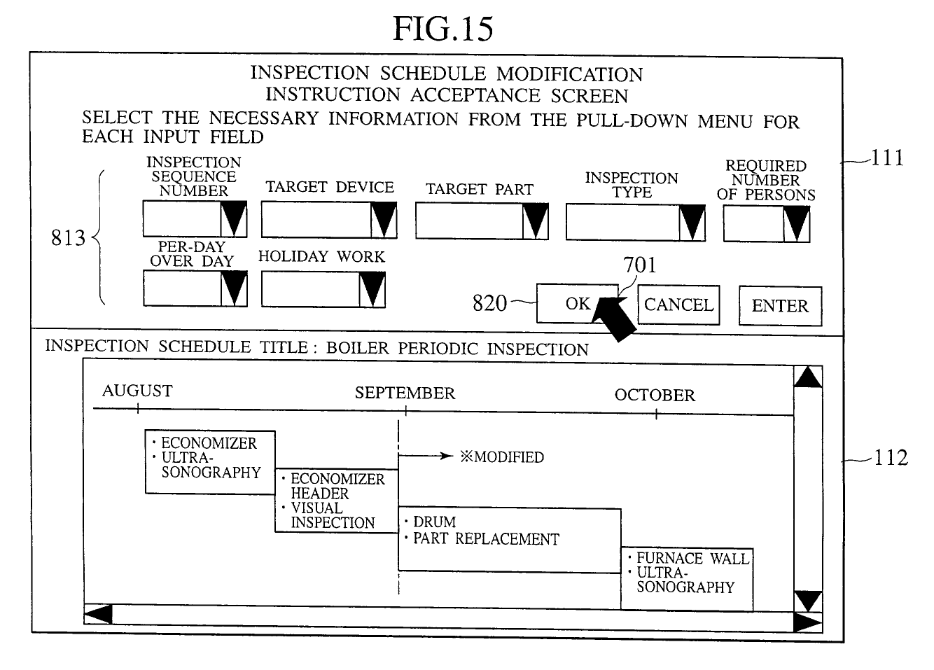

FIGS. 14 and 15 are diagrams each showing an example of the inspection schedule modification instruction acceptance screen. As shown in the figures, the inspection schedule modification instruction acceptance screen is made up of two child screens 111 and 112 as is the inspection schedule preparation instruction acceptance screen shown in FIGS. 11 to 13. The child screen 111 is used to accept information necessary for modifying an inspection schedule, and includes the group of input fields 813 for accepting inspection item specification information, as does the child screen 111 shown in FIGS. 12 and 13. The child screen 112, on the other hand, is used to display modifications to the inspection schedule data 1060 having inspection schedule identification data 1061 indicated by the operator at the user terminal 4 on the LAN 5 side.

On the inspection schedule modification instruction acceptance screen shown in FIG. 14, when the operator at the user terminal 4 on the LAN 5 side has selected the enter button 703 using the cursor 701 and an input device such as a keyboard, the inspection item specification information held in the group of input fields 813 is transmitted from the user terminal 4 on the LAN 5 side to the inspection schedule management apparatus 1.

Upon receiving the inspection item specification information through the LAN IF section 101 and the main control section 103, the inspection schedule preparation section 105 creates inspection item data 1063 using the inspection item specification information in the same way as in the creation of inspection schedule data described above. The inspection schedule preparation section 105 then inputs the created inspection item data 1063 to the main control section 103. In response, the main control section 103 performs processing such that the inspection item data 1063 which is included in the inspection schedule data 1060 read out by the inspection schedule retrieval section 104 and whose inspection sequence number is the same as that included in the inspection item specification information is replaced by the above created inspection item data 1063. Furthermore, the main control section 103 modifies the “estimated inspection time period” 10632 of each piece of inspection item data 1063 whose inspection sequence number is larger than that of the created inspection item data 1063 such that it matches the inspection end date indicated by the “estimated inspection time period” 10632 of the above created inspection item data 1063. The main control section 103 then creates display data for displaying, in the calendar, the inspection items indicated by the inspection data 1063 included in the inspection schedule data 1060 and modified as described above, and updates the display contents of the child screen 112 by the created display data and clears the group of input fields 813 in the child screen 111 so that inspection item specification information can be newly accepted.

Thus, the Gantt chart for the inspection schedule in the child screen 112 is modified as in the inspection schedule modification instruction acceptance screen in FIG. 15. Then, if the operator at the user terminal 4 on the LAN 5 side selects the enter button 820 using the cursor 701 and an input device such as a keyboard, a termination instruction is transmitted from the user terminal 4 on the LAN 5 side to the inspection schedule management apparatus 1. Upon receiving the termination instruction, the main control section 103 controls the inspection schedule preparation section 105 so as to update each piece of the modified inspection item data 1063 included in the inspection schedule data 1060 read out by the inspection schedule retrieval section 104.

After the inspection schedule preparation section 105 modifies the inspection schedule data 1060, the main control section 103 transmits it to the manpower dispatch ordering apparatus 2 and the parts ordering apparatus 3 at step S1016.

On the other hand, at step S1017, the main control section 103 obtains order information which includes information specifying inspection schedule data 1060 and inspection item data 1063 (such as inspection schedule identification data 1061, “device to be inspected” 10631, “estimated inspection time period” 10632) and information specifying the contents of an order for manpower dispatch or parts (such as “required number of persons” 10634 or “required part” 10638 and “manpower dispatcher” 10635 or “parts supplier” 10639).

At step S1018, the main control section 103 supplies the inspection schedule preparation section 105 with the order information and instructs the inspection schedule preparation section 105 to update the inspection schedule data 1060. In response, the inspection schedule preparation section 105 specifies the inspection item data 1063 to be updated included in the inspection schedule data 1060 from the inspection schedule DB 106 based on the order information. Then, to the inspection item data 1063, the inspection schedule preparation section 105 adds the information which is included in the order information and which specifies the contents of the order for manpower dispatch or parts.

This completes the description of the inspection schedule management apparatus 1.

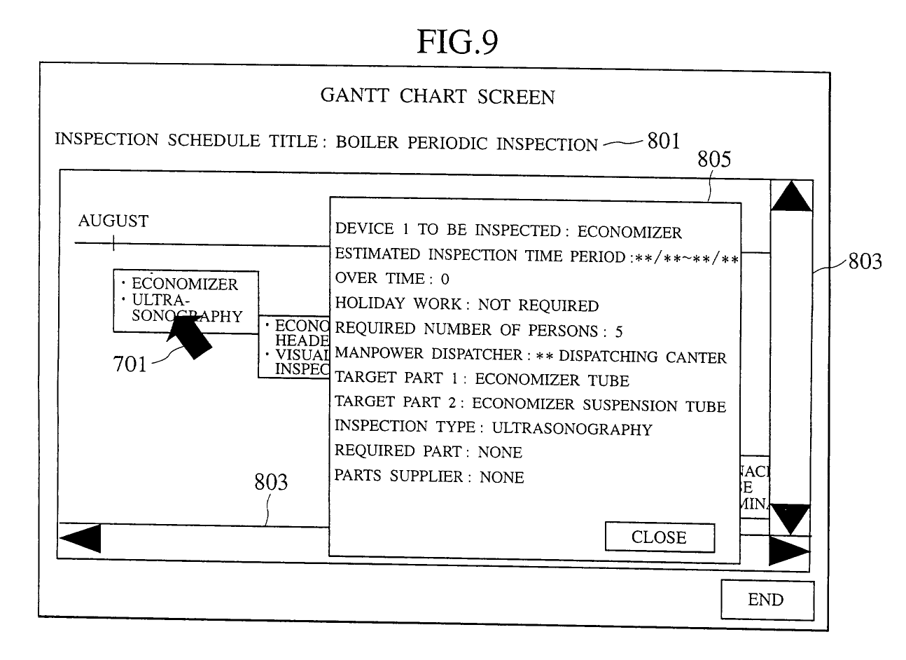

It should be noted that in the flow of FIG. 6, the processing carried out after the inspection schedule management apparatus 1 is accessed by the user terminal 4 on the LAN 5 side may be performed according to instructions issued from the input device included in the inspection schedule management apparatus 1. In such a case, the inspection schedule management apparatus 1 displays the various screens shown in FIGS. 7 to 15 on its own display device.

Next, the manpower dispatch ordering apparatus 2 will be described.

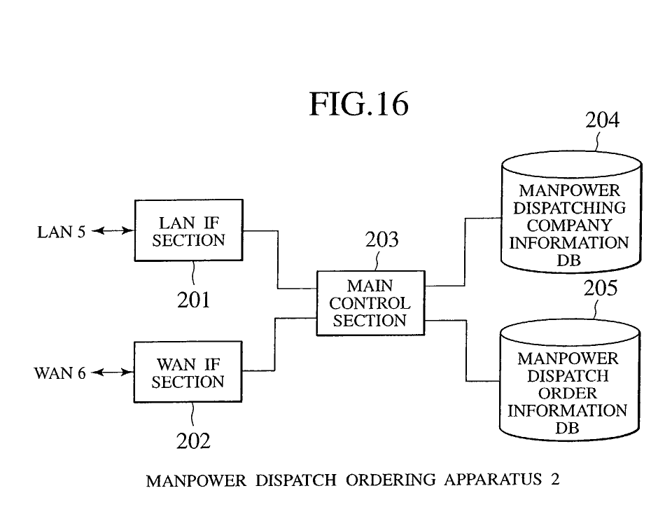

FIG. 16 is a block diagram showing the function of the manpower dispatch ordering apparatus 2.

The manpower dispatch ordering apparatus 2 comprises a LAN IF section 201 for communications through the LAN 5, a WAN IF section 202 for communications through the WAN 6, a main control section 203, a manpower dispatching company information DB 204, and a manpower dispatch order information DB 205.

Information on manpower dispatching companies is stored in the manpower dispatching company information DB 204.

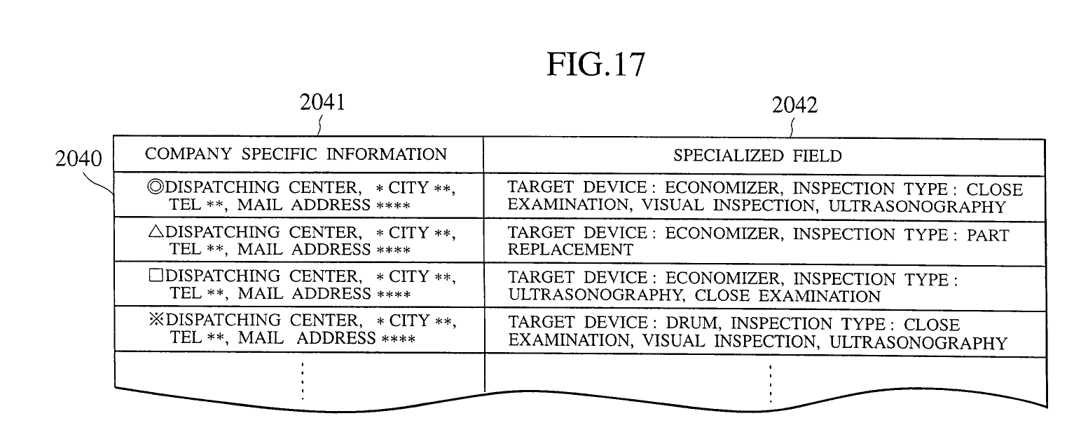

FIG. 17 is a diagram showing an example of what is registered in the manpower dispatching company information DB 204.

As shown in the figure, each manpower dispatching company information record 2040 includes a field 2041 for holding data specifying a manpower dispatching company (such as the company name, address, telephone number, email address, etc.) and a field 2042 for holding data specifying the specialized field of a manpower dispatching company (such as a target device and inspection types).

A manpower dispatch order information management TB (table) is stored in the manpower dispatch order information DB 205 for each piece of inspection schedule data 1060 received from the inspection schedule management apparatus 1.

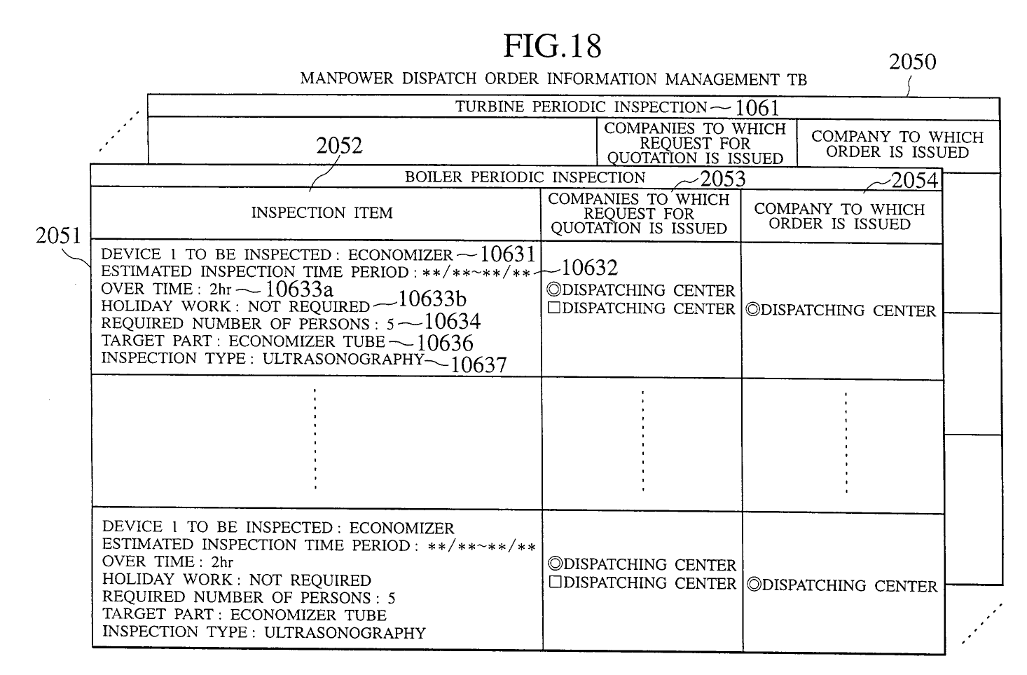

FIG. 18 is a diagram showing an example of what is registered in the manpower dispatch order information DB 205. As shown in the figure, each manpower dispatch order information management TB 2050 stored in the manpower dispatch order information DB 205 includes inspection schedule identification data 1061 and management data 2051 provided for each piece of inspection item data 1063 included in the inspection schedule data 1060 having the above identification data 1061. The management data 2051 is used to manage companies which receive requests for quotation or orders.

The management data 2051 includes a field 2052 for holding data which is included in the corresponding inspection item data 1063 and which is necessary to order manpower (i.e. “device to be inspected” 10631, “estimated inspection time period” 10632, “per-day over time” 10633a, “whether holiday work is required” 10633b, “required number of persons” 10634, “target part” 10636, and “inspection type” 10637) and a field 2053 for registering companies which receive requests for quotation and a field 2054 for registering a company which receives orders.

The main control section 203 receives inspection schedule data 1060 from the inspection schedule management apparatus 1 through the LAN IF section 201, and registers a corresponding manpower dispatch order information management TB 2050 in the manpower dispatch order information DB 205 or updates it. Furthermore, for each inspection item included in the inspection schedule data 1060 corresponding to the manpower dispatch order information management TB 2050, the main control section 203 determines candidate manpower dispatchers from which an order recipient is selected based on the data which is held in the field 2052 in each piece of management data 2051 in the manpower dispatch order information management TB 2050 and which is necessary to order manpower, and manpower dispatching company information 2040 stored in the manpower dispatching company DB 204. The main control section 203 transmits a request for quotation to the user terminal 4 of each candidate for receiving orders or transmits an order to an order recipient selected from the candidates. The main control section 203 also prepares the order information, described earlier, and transmits it to the inspection schedule management apparatus 1.

The above manpower dispatch ordering apparatus 2 also can be implemented on a computer system having a general configuration (for example, one as shown in FIG. 5) as can the inspection schedule management apparatus 1. A program for implementing each functional block of the manpower dispatch ordering apparatus 2 on such a computer may be loaded into the memory 902 from the external storage device 903, or from the storage medium 904 through the reading device 905. Or alternatively, the program may be loaded into the memory 902 from the LAN 5 or the WAN 6 through the communication device 908. In the above case, the external storage device 903 may be used for (storing) the manpower dispatching company information DB 204 and the manpower dispatch order information DB 205.

Description will be made below of the operation of the manpower dispatch ordering apparatus 2 having the above configuration.

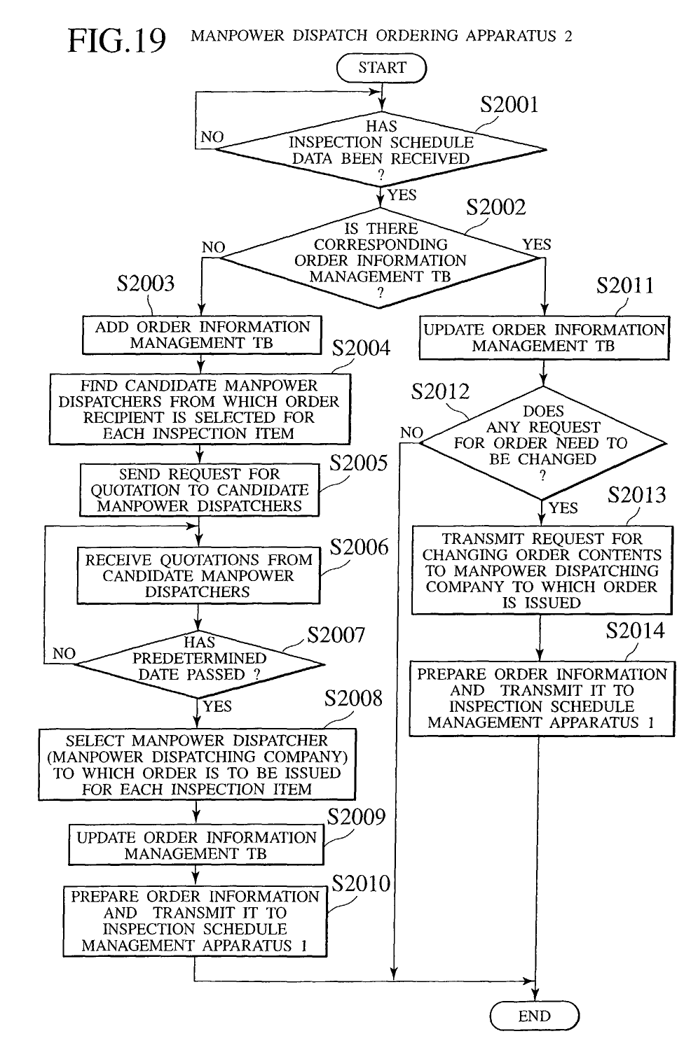

FIG. 19 is a flowchart illustrating the operation of the manpower dispatch ordering apparatus 2.

At step S2001, the main control section 203 receives inspection schedule data 1060 from the inspection schedule management apparatus 1 through the LAN IF section 201. At step S2002, the main control section 203 checks whether a manpower dispatch order information management TB 205 having the same inspection schedule identification data 1061 as that included in the inspection schedule data 1060 is registered in the manpower dispatch order information DB 205. If not, the processing flow proceeds to step S2003; otherwise the processing flow proceeds to step S2011.

At step S2003, to the manpower dispatch order information DB 205, the main control section 203 adds a manpower dispatch order information management TB 2050 which has the same inspection schedule identification data 1061 as that included in the inspection schedule data 1060 received from the inspection schedule management apparatus 1 and which includes management data 2051 corresponding to each piece of the inspection item data 1063 included in the inspection schedule data 1060. Then, in the field 2052 of each piece of management data 2051 in the manpower dispatch order information management TB 2050, the main control section 203 registers “device to be inspected” 10631, “estimated inspection time period” 10632, “per-day over time” 10633a, “whether holiday work is required” 10633b, “required number of persons” 10634, “target part” 10636, and “inspection type” 10637 included in the corresponding inspection item data.

After that, for each piece of management data 2051 included in the manpower dispatch order information TB 2050, the main control section 203 finds candidate manpower dispatchers from which an order recipient is selected for carrying out inspection according to the inspection items stored in the field 2052 at step S2004. Specifically, the main control section 203 searches the manpower dispatching company information DB 204 for manpower dispatching company information records 2040 whose field 2042 holds the same “device to be inspected” 10631 and “inspection type” 10637 as those stored in the field 2052 of the management data 2051, and selects the manpower dispatching companies registered in the records 2040 as candidates for receiving orders. Then, in the field 2053 of the management data 2051, the main control section 203 stores information on the manpower dispatching companies selected as candidates for receiving orders.

At step S2005, for each piece of management data 2051 included in the manpower dispatch order information TB 2050, the main control section 203 creates quotation request data including information on the inspection item registered in the field 2052, and transmits it to the user terminal 4 of each manpower dispatching company registered in the field 2053 through the WAN IF section 202.

On the other hand, each manpower dispatching company checks the quotation request data sent to its user terminal 4 from the manpower dispatch ordering apparatus 2, and prepares a quotation. Then, each manpower dispatching company transmits quotation data (which includes the information on the inspection item included in the quotation request data) to the manpower dispatch ordering apparatus 2. The main control section 203 tries to receive the quotation data, which is a response to the quotation request data, until a predetermined date (for example, the last day of the month in which the quotation request data was sent) passes, at steps S2006 and S2007. The main control section 203 then classifies each piece of received quotation data by inspection item (information on the inspection items) included in the quotation data to manage them.

If it is determined at step S2007 that the predetermined date has passed, the main control section 203 selects one of the pieces of quotation data received so far for each piece of inspection item information. The main control section 203 then selects the sender of the piece of quotation data selected for each piece of inspection item information, as a manpower dispatching company which receives an order for manpower dispatch to carry out an inspection indicated by the corresponding inspection item, at step S2008. After that, the main control section 203 stores information on the manpower dispatching company selected as an order recipient in the field 2054 of the management data 2051 whose field 2052 holds information on the corresponding inspection item, at step S2009. Furthermore, to the user terminal 4 of the manpower dispatching company selected as the order recipient, the main control section 203 transmits order request data including the quotation data received from the manpower dispatching company.

It should be noted that the maintenance company may select the piece of the quotation data using its user terminal 4 and transmit the selection result from its user terminal 4 to the inspection schedule management apparatus 1 after the main control section 203 transmits the quotation data classified for each piece of inspection item information to the user terminal 4 of the maintenance company through the LAN IF section 201. Or alternatively, for each piece of inspection item information, the main control section 203 automatically selects (detects) a piece of quotation data indicating the smallest estimated amount from among the quotation data classified for each piece of inspection item information.

After entering the necessary information in the fields 2052 to 2054 of each piece of management data 2051 included in the manpower dispatch order information management TB 2050 added at step S2003 as described above, the main control section 203 prepares order information which includes the information entered in the fields 2052 and 2054 of each piece of management data 2051 in the manpower dispatch order information management TB 2050 and the inspection schedule identification data 1061, and transmits the prepared order information to the inspection schedule management apparatus 1 through the LAN IF section 201 at step S2010.

On the other hand, at step S2011, by use of each piece of inspection item data 1063 included in inspection schedule data 1060 received from the inspection schedule management apparatus 1, the main control section 203 updates the inspection item information held in the field 2052 of each piece of management data 2051 included in the manpower dispatch order information management TB 2050 having the same inspection identification data as that included in the inspection schedule data 1060.

Specifically, for each piece of management data 2051, the main control section 203 selects (detects) from the inspection schedule data 1060 inspection item data 1063 whose “device to be inspected” 10631 and “target part” 10636 coincide with those stored in the field 2052. After that, the main control section 203 checks whether “estimated inspection time period” 10632, “per-day over time” 10633a, “whether holiday work is required” 10633b, “required number of persons” 10634, and “inspection type” 10637 indicated by the inspection item data 1063 coincide with those stored in the field 2052. If they do not coincide, the main control section 203 updates “estimated inspection time period” 10632, “per-day over time” 10633a, “whether holiday work is required” 10633b, “required number of persons” 10634, and “inspection type” 10637 stored in the field 2052 by those indicated by the inspection item data 1063.

At step S2012, the main control section 203 checks whether it is necessary to change the contents of the orders issued to the order recipients managed through the use of the manpower dispatch order information management TB 2050, as a result of the above update of the manpower dispatch order information management TB 2050. For example, if an order recipient is registered in the field 2054 of the management data 2051 whose field 2052 has been updated, it is determined that the contents of orders to the order recipient must be changed. Then, the main control section 203 creates order change request data which includes the inspection item information held in the field 2052 of the management data 2051 whose field 2052 has been updated, and transmits it to the order recipient registered in the field 2054, at step S2013.

The main control section 203 then prepares order information including information held in the fields 2052 and 2054 of each piece of management data 2051 included in the manpower dispatch order information management TB 2050 updated at step S2011 and the inspection schedule identification data 1061, and transmits the order information to the inspection schedule management apparatus 1 through the LAN IF section 201 at step S2014.

This completes the description of the manpower dispatch ordering apparatus 2.

Next, the parts ordering apparatus 3 will be described.

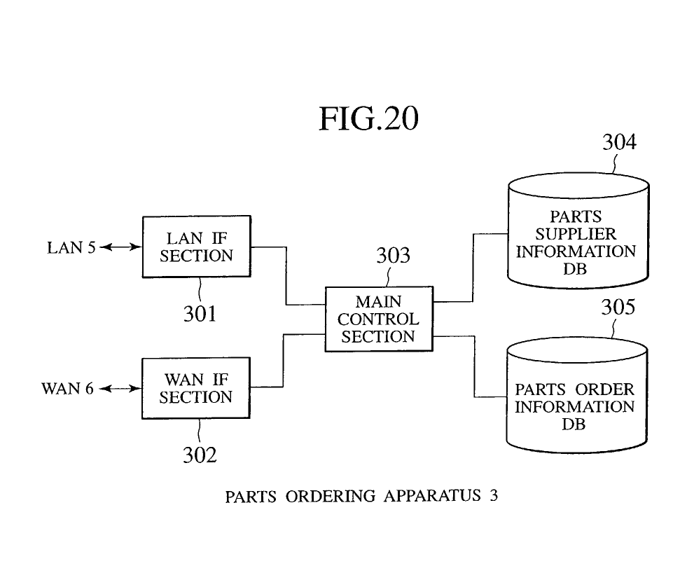

FIG. 20 is a block diagram showing the function of the parts ordering apparatus 3.

The parts ordering apparatus 3 comprises a LAN IF section 301 for communications through the LAN 5, a WAN IF section 302 for communications through the WAN 6, a main control section 303, a parts supplier information DB 304, and a parts order information DB 305.

Information on parts suppliers is stored in the parts supplier information DB 304.

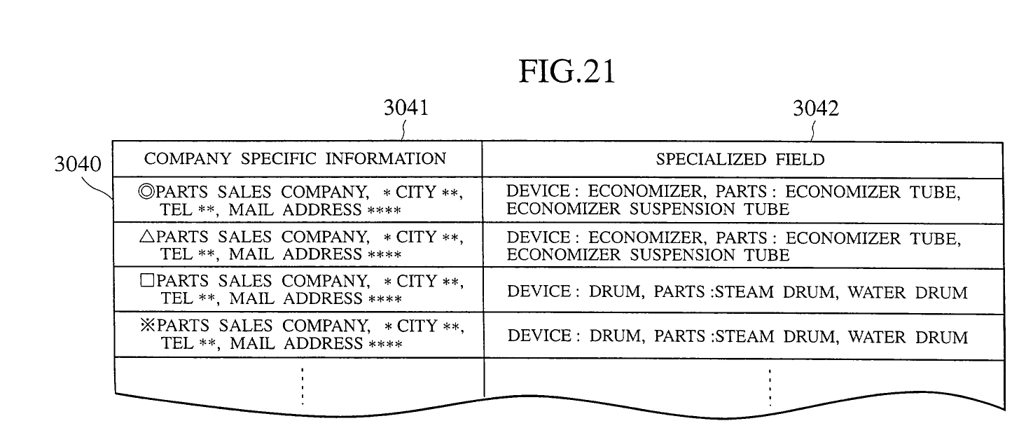

FIG. 21 is diagram illustrating an example of what is registered in the parts supplier information DB 304.

As shown in the figure, each parts supplier information record 3040 includes a field 3041 for holding data specifying a parts supplier (such as the supplier name, address, telephone number, e-mail address, etc.) and a field 3042 for holding data specifying the specialized parts sales field of the parts supplier (such as the target device and target parts).

A parts order information management TB (table) is stored in the parts order information DB 305 for each piece of inspection schedule data 1060 received from the inspection schedule management apparatus 1.

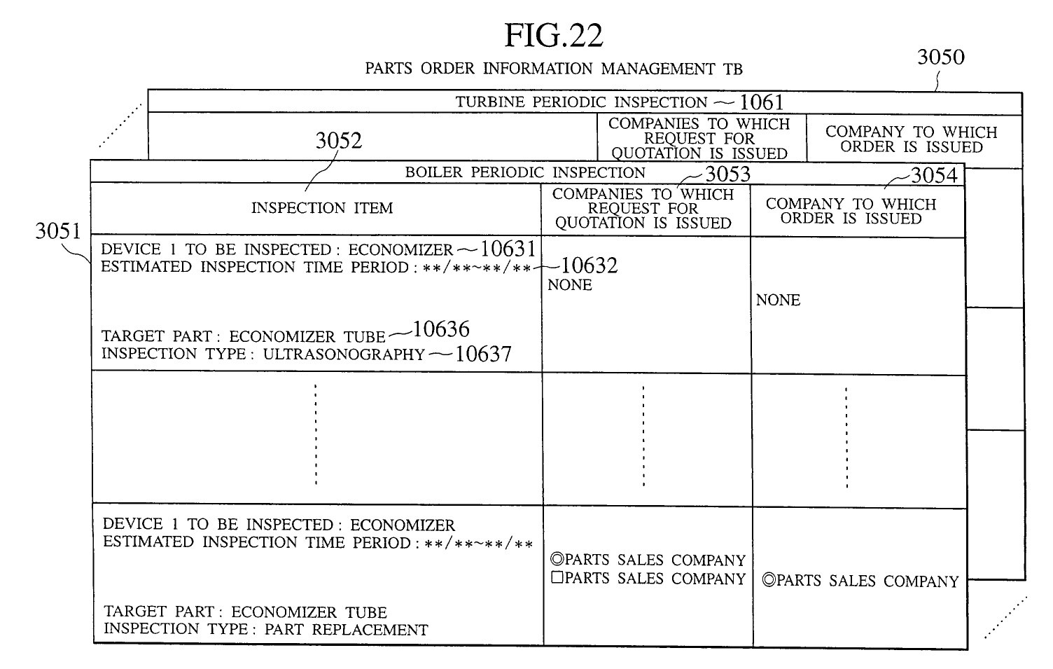

FIG. 22 is a diagram illustrating an example of what is registered in the parts order information DB 305. As shown in the figure, each parts order information management TB 3050 stored in the parts order information DB 305 includes inspection schedule identification data 1061 and management data 3051 provided for each piece of inspection item data 1063 included in the inspection schedule data 1060 having the same identification data as the above inspection schedule identification data 1061. The management data 3051 is used to manage companies which receive requests for quotation or orders.

The management data 3051 includes a field 3052 for holding data which is included in the corresponding inspection item data 1063 and which is necessary to order parts (i.e. “device to be inspected” 10631, “estimated inspection time period” 10632, “target part” 10636, and “inspection type” 10637) and a field 3053 for registering companies which receive requests for quotation and a field 3054 for registering a company which receives orders.

The main control section 303 receives inspection schedule data 1060 from the inspection schedule management apparatus 1 through the LAN IF section 301, and registers a corresponding parts order information management TB 3050 in the parts order information DB 305 or updates it. Furthermore, for each inspection item included in the inspection schedule data 1060 corresponding to the parts order information management TB 3050, the main control section 303 determines candidate parts suppliers from which an order recipient is selected based on data which is registered in the field 3052 of each piece of management data 3051 in the parts order information management TB 3050 and which is necessary to order parts, and parts supplier information 3040 stored in the parts supplier information DB 304. The main control section 303 then transmits a request for quotation to the user terminal 4 of each candidate for receiving orders or transmits an order to an order recipient selected from the candidates. The main control section 303 also prepares the order information, described above, and transmits it to the inspection schedule management apparatus 1.

The above parts ordering apparatus 3 also can be implemented on a computer system having a general configuration (for example, one shown in FIG. 5) as can the inspection schedule management apparatus 1. A program for implementing each functional block of the parts ordering apparatus 3 on such a computer system may be loaded into the memory 902 from the external storage device 903, or from the storage medium 904 through the reading device 905. Or alternatively, the program may be loaded into the memory 902 from the LAN 5 or the WAN 6 through the communication device 908. In the above case, the external storage device 903 may be used for (storing) the parts supplier information DB 304 and the parts order information DB 305.

Description will be made below of the operation of the parts ordering apparatus 3 having the above configuration.

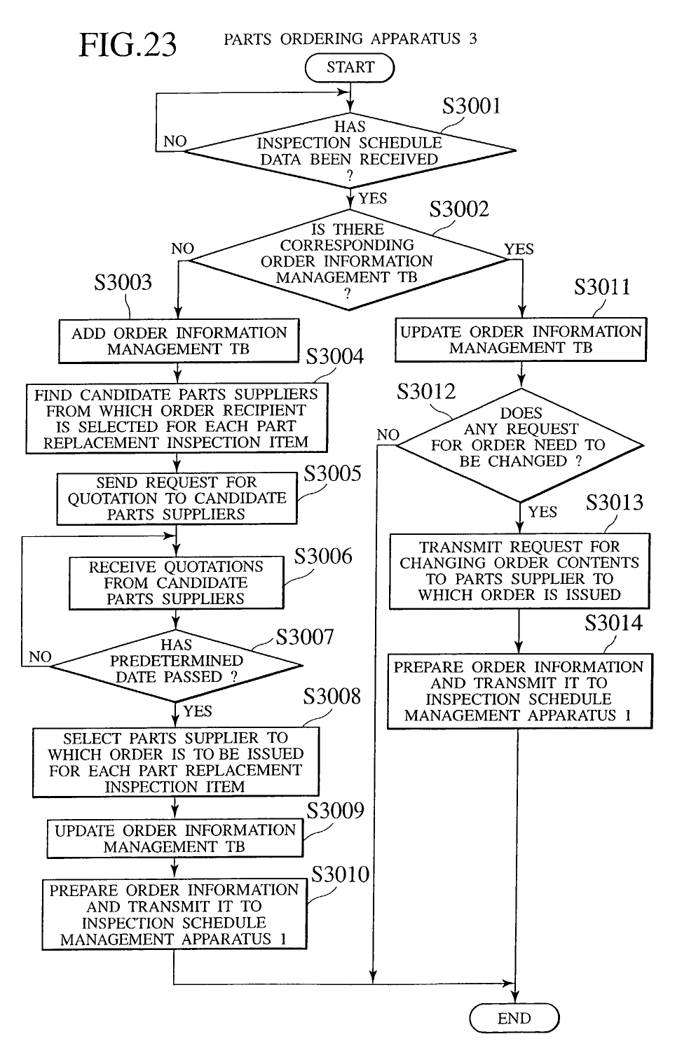

FIG. 23 is a flowchart illustrating the operation of the parts ordering apparatus 3.

At step S3001, the main control section 303 receives inspection schedule data 1060 from the inspection schedule management apparatus 1 through the LAN IF 301. At step S3002, the main control section 303 checks whether a parts order information management TB 3050 having the same inspection schedule identification data 1061 as that included in the inspection schedule data 1060 is registered with the parts order information DB 305. If not, the processing flow proceeds to step S3003; otherwise the processing flow proceeds to step S3011.

At step S3003, to the parts order information DB 305, the main control section 303 adds a parts order information management TB 3050 which has the same inspection schedule identification data 1061 as that included in the inspection schedule data 1060 received from the inspection schedule management apparatus 1 and which includes management data 3051 corresponding to each piece of the inspection item data 1063 included in the inspection schedule data 1060. Then, in the field 3052 of each piece of management data 3051 in the parts order information management TB 3050, the main control section 303 registers “device to be inspected” 10631, “estimated inspection time period” 10632, “target part” 10636, and “inspection type” 10637 included in the corresponding inspection item data.

After that, for each piece of management data 3051 which is included in the parts order information management TB 3050 and whose field 3052 includes the value “part replacement” set for “inspection type” 10637, the main control section 303 finds candidate parts suppliers for receiving orders for “target part” 10636 registered in the field 3052 at step S3004. Specifically, the main control section 303 searches the parts supplier information DB 304 for the parts supplier information records 3040 whose field 3042 holds the same “device to be inspected” 10631 and “target part” 10636 as those stored in the field 3052 of the management data 3051, and selects the parts suppliers registered in the records 3040 as candidates for receiving orders. Then, in the field 3053 of the management data 3051, the main control section 303 stores information on the parts suppliers selected as candidates for receiving orders.

At step S3005, for each piece of management data 3051 whose field 3053 holds candidate parts suppliers for receiving orders, the main control section 303 creates quotation request data including information on the inspection item registered in the field 3052, and transmits it to the user terminal 4 of each parts supplier registered in the field 3053 through the WAN IF section 302.

On the other hand, each parts supplier checks the quotation request data sent to its user terminal 4 from the parts ordering apparatus 3, and prepares a quotation. Then, each parts supplier transmits quotation data (which includes the information on the inspection item included in the quotation request data) to the parts ordering apparatus 3. The main control section 303 tries to receive the quotation data, which is a response to the quotation request data, until a predetermined date (for example, the last day of the month in which the quotation request data was sent) passes, at step S3006 and S3007. The main control section 303 then classifies each piece of received quotation data by inspection item (information on the inspection items) included in the quotation data to manage them.

If it is determined at step S3007 that the predetermined date has passed, the main control section 303 selects one of the pieces of quotation data received so far for each piece of inspection item information. The main control section 303 then selects the sender of the piece of quotation data selected for each piece of inspection item information, as a parts supplier which receives an order for parts necessary for the corresponding inspection item, at step S3008. After that, the main control section 303 stores information on the parts supplier selected as the order recipient in the field 3054 of the management data 3051 whose field 3052 holds information on the corresponding inspection item, at step S3009. Furthermore, to the user terminal 4 of the parts supplier selected as the order recipient, the main control section 303 transmits order request data including the quotation data received from the parts supplier.

It should be noted that the maintenance company may select the piece of the quotation data using its user terminal 4 or the main control section may automatically select it, as in the case of the manpower dispatch ordering apparatus 2 described earlier.

After registering the necessary information in the fields S3052 to S3054 of each piece of management data 3051 included in the parts order information management TB 3050 added at step S3003, the main control section 303 prepares order information which includes the information entered in the fields 3052 and 3054 of each piece of management data 3051 in the parts order information management TB 3050 and the inspection schedule identification data 1061, and transmits the prepared order information to the inspection schedule management apparatus 1 through the LAN IF section 301 at step S3010.

On the other hand, at step S3011, by use of each piece of inspection item data 1063 included in inspection schedule data 1060 received from the inspection schedule management apparatus 1, the main control section 303 updates the information item information held in the field 3052 of each piece of management data 3051 included in the parts order information management TB 3050 having the same inspection schedule identification data 1061 as that included in the inspection schedule data 1060.

Specifically, for each piece of management data 3051, the main control section 303 selects (detects) from the inspection schedule data 1060 inspection item data 1063 whose “device to be inspected” 10631 and “target part” 10636 coincide with those stored in the field 3052. After that, the main control section 303 checks whether “estimated inspection time period” 10632 and “inspection type” 10637 indicated by the inspection item data 1063 coincide with those stored in the field 3052. If they do not coincide, the main control section 303 updates “estimated inspection time period” 10632 and “inspection type” 10637 stored in the field 3052 by those indicated by the inspection item data 1063.

At step S3012, the main control section 303 checks whether it is necessary to change the contents of the orders issued to the order recipients managed through the use of the parts order information management TB 3050, as a result of the above update of the parts order information management TB 3050. For example, if an order recipient is registered in the field 3054 of management data 3051 whose field 3052 has been updated, it is determined that the contents of orders to the order recipient must be changed. Then, the main control section 303 creates order change request data including the inspection item information held in the field 3052 of the management data 3051 whose field 3052 has been updated, and transmits it to the order recipient registered in the field 3054, at step S3013.

The main control section 303 then prepares order information including information held in the fields 3052 and 3054 of each piece of management data 3051 included in the parts order information management TB 3050 updated at step S3011 and the inspection schedule identification data 1061, and transmits the order information to the inspection schedule management apparatus 1 through the LAN IF section 301 at step S3014.

This completes the description of the parts ordering apparatus 3.

Furthermore, this completes the description of an embodiment of the present invention.

With the above configuration of the present embodiment, the operator at the user terminal 4 of the maintenance company only needs to specify the following items for power plant equipment inspection: the inspection start date, each device to be inspected, the inspection sequence number of each device to be inspected, the inspection type of each device to be inspected, and the number of persons required for an inspection of the inspection type of each device to be inspected. Then, the inspection schedule management apparatus 1 calculates the estimated number of days required for the inspection of each device to be inspected, prepares inspection schedule data 1060 of the power plant equipment, and stores it in the inspection schedule DB 106. The inspection schedule data 1060 (a Gantt chart for inspection schedule) can be viewed from the user terminal 4 of each linked company.

Therefore, the present embodiment makes it possible to reduce the burden on persons responsible for preparing the inspection process schedule and notifying each linked company of the inspection schedule, resulting in reliable notification to each linked company.

Further, according to the present embodiment, for each device to be inspected indicated by inspection schedule data 1060 stored in the inspection schedule DB 106, the manpower dispatch ordering apparatus 2 prepares a manpower dispatch order request for dispatching persons by the estimated inspection start date of the device to perform inspection corresponding to the inspection type of the device. The manpower dispatch ordering apparatus 2 then transmits the manpower dispatch order request to the user terminal 4 of a manpower dispatching company. In addition, when the inspection schedule data 1060 stored in the inspection schedule DB 106 has been modified, the manpower dispatch ordering apparatus 2 determines, for each device to be inspected indicated by the modified inspection schedule data 1060, whether it is necessary to change the contents of the order request by comparing the inspection items of the device to be inspected indicated by the modified inspection schedule data 1060 against the inspection items of the same device registered with manpower dispatch order information DB 205. If it is determined that it is necessary to change the contents, the manpower dispatch ordering apparatus 2 prepares an order contents change request and transmits it to the user terminal 4 of the manpower dispatching company to which order requests are transmitted.

Therefore, the present embodiment makes it possible to reduce the burden on persons responsible for issuing the manpower dispatch order request or changing it, which is necessary to carry out inspection according to prepared or changed inspection schedule data 1060.

Still further according to the present embodiment, for each device to be inspected indicated by the inspection schedule data 1060 stored in the inspection schedule DB 106, when the inspection type is “parts replacement”, the parts ordering apparatus 3 prepares a parts order request for supplying a replacement part by the estimated inspection start date of the device. The parts ordering apparatus 3 then transmits the parts order request to the user terminal 4 of a parts supplier. In addition, when the inspection schedule data 1060 stored in the inspection schedule DB 106 has been modified, the parts ordering apparatus 3 determines, for each device to be inspected indicated by the modified inspection schedule data 1060, whether it is necessary to change the contents of the order request by comparing the inspection items of the device to be inspected indicated by the modified inspection schedule data against the inspection items of the same device registered with the parts order information DB 305. If it is determined that it is necessary to change the contents, the parts ordering apparatus 3 prepares an order contents change request and transmits it to the user terminal 4 of the parts supplier to which order requests are transmitted.

Therefore, the present embodiment makes it possible to reduce the burden on persons responsible for issuing the parts order request or changing it, which is necessary to carry out inspection according to prepared or changed inspection schedule data 1060.

It should be noted that the present invention is not limited to the above embodiment. Rather, modifications and variations may be made to the disclosed embodiment without departing from the subject and spirit of the present invention.

For example, an inspection schedule modification instruction which includes an inspection sequence number and the estimated inspection end date of an inspection item may be accepted on the inspection schedule modification instruction acceptance screen shown in FIGS. 14 and 15. With this arrangement, the estimated inspection time period of the inspection item indicated by the inspection sequence number included in the inspection schedule modification instruction may be calculated based on the estimated inspection end date of the immediately previous inspection item (having an inspection sequence number one smaller than that included in the inspection schedule modification instruction) and the estimated inspection end date included in the inspection schedule modification instruction. Then, the number of persons required to complete the inspection within the calculated estimated inspection time period may be determined using the standard number of persons and the standard inspection time period included in the basic data corresponding to this inspection item. The inspection schedule data may be modified based on the determined number of persons required for the inspection.

Further in the above embodiment, the inspection schedule management apparatus 1, the manpower dispatch ordering apparatus 2, and the parts ordering apparatus 3 may be implemented on a same computer. Still further, even though the above embodiment provides support for managing an inspection schedule for power plant equipment, the present invention can be applied to support for inspection schedule management of various plant equipment other than power plant equipment, such as chemical plant equipment.

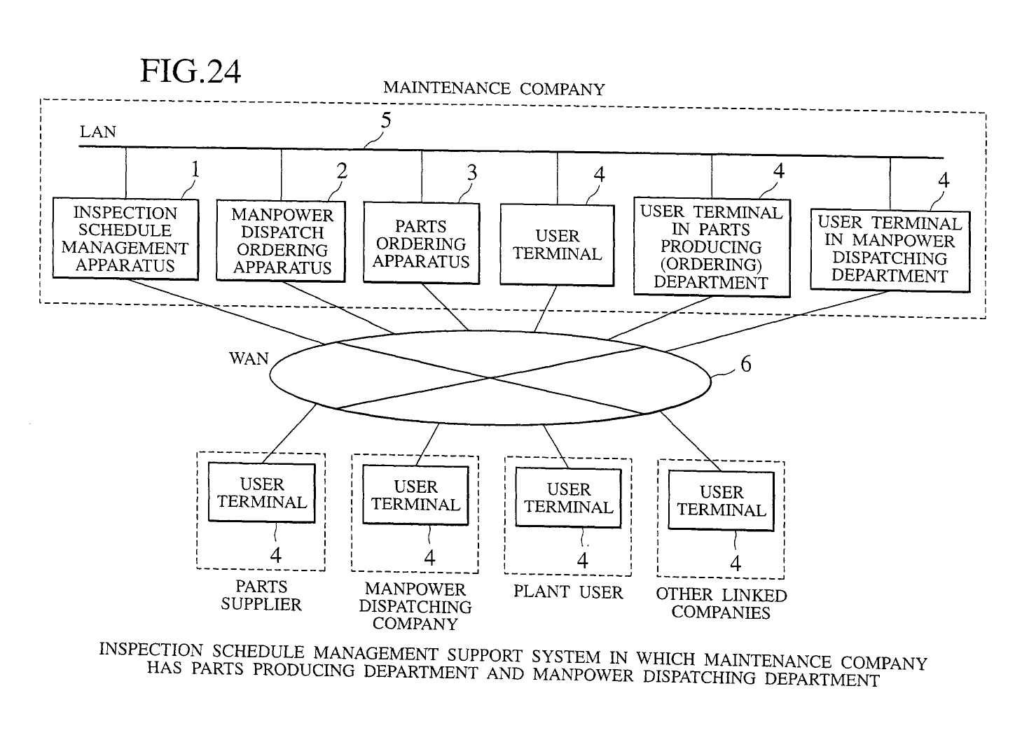

Still further in the above embodiment, if the maintenance company has a parts producing department and a manpower dispatching department, the user terminal 4 of the maintenance company and the user terminal 4 of each manpower dispatching company may be connected through the LAN 5. This arrangement produces the same effect as described above. FIG. 24 is a schematic system diagram for such an arrangement.

As described above, the present invention can provide support for managing an inspection schedule for plant equipment so as to reduce the burden on preparation of the inspection schedule.

While the invention has been described in its preferred embodiments, it is to be understood that the words which have been used are words of description rather than limitation and that changes within the purview of the appended claims may be made without departing from the true scope and spirit of the invention in its broader aspects.

What is claimed is:

1. An inspection schedule management support system for providing support for managing an inspection schedule for plant equipment, said system comprising:
an inspection schedule database for storing inspection schedule data of said plant equipment, said inspection schedule data including, for each device to be inspected, an estimated inspection start date, an estimated inspection end date, an inspection type, and the number of persons required for inspection;
a basic database for storing one or more pieces of basic data including, for each device constituting said plant equipment, an inspection type and the number of days required for a predetermined number of persons to complete an inspection of said inspection type;
inspection schedule display means for causing a terminal to display an inspection schedule of said plant equipment indicated by said inspection schedule data stored in said inspection schedule database, said terminal being connected to said inspection schedule display means through a network;
instruction accepting means for accepting from an operator an inspection schedule preparation instruction including, for said plant equipment, an inspection start date, specification of each device to be inspected, an inspection sequence number of each specified device to be inspected, an inspection type of each specified device to be inspected, and the number of persons assigned to an inspection of said inspection type of each specified device to be inspected; and
inspection schedule preparation means for calculating the estimated number of days required for said inspection of said each device to be inspected based on said inspection type of said each device to be inspected and said number of persons assigned to said inspection and basic data of said each device to be inspected, and preparing inspection schedule data of said plant equipment based on a result of said calculation and said inspection start date and said inspection sequence number of said each device to be inspected for said plant equipment, wherein said inspection type, said number of persons, said inspection start date, and said inspection sequence number are included in said inspection schedule preparation instruction accepted by said instruction accepting means.

2. The inspection schedule management support system as claimed in claim 1, wherein said instruction accepting means accepts from an operator an inspection schedule modification instruction including specification of a device to be inspected and either an inspection type of said specified device to be inspected or the number of persons assigned to said inspection or both, and
wherein said inspection schedule preparation means recalculates the estimated number of days required for said inspection of said device to be inspected based on either said inspection type or said number of persons assigned to said inspection or both and basic data of said device to be inspected, and modifies said inspection schedule data of said plant equipment stored in said inspection schedule database so as to change inspection schedule of devices whose inspection sequence number is larger than said inspection sequence number of said device to be inspected based on a result of said recalculation, wherein (said specification of) said device to be inspected and either said inspection type or said number of persons or both are included in said inspection schedule modification instruction accepted by said instruction accepting means.

3. The inspection schedule management support system as claimed in claim 1, further comprising:
manpower dispatch order request means for, for each device to be inspected indicated by said inspection schedule data of said plant equipment stored in said inspection schedule database, preparing a manpower dispatch order request for dispatching persons by an estimated inspection start date of the device to perform an inspection corresponding to an inspection type of the device, and transmitting said manpower dispatch order request to a predetermined terminal connected to said manpower dispatch order request means through a network.

4. The inspection schedule management support system as claimed in claim 3, wherein when said inspection schedule data of said plant equipment stored in said inspection schedule database has been modified, said manpower dispatch order request means determines, for each device to be inspected indicated by said modified inspection schedule data, whether it is necessary to change contents of an order request, and if it is determined that it is necessary to change said contents, said manpower dispatch order request means prepares an order contents change request for said manpower dispatch order request and transmits it to said predetermined terminal.

5. The inspection schedule management support system as claimed in claim 3, wherein said manpower dispatch order request means performs steps of:
preparing a request for quotation before preparing said manpower dispatch order request;
transmitting said request for quotation to a plurality of terminals connected to said manpower dispatch order request means through a network, said plurality of terminals including said predetermined terminal;
receiving quotation data from said plurality of terminals;
selecting one piece of said quotation data received from said plurality of terminals; and
transmitting said manpower dispatch order request to said predetermined terminal which transmitted said selected piece of said quotation data.

6. The inspection schedule management support system as claimed in claim 4, wherein said manpower dispatch order request means performs steps of:
preparing a request for quotation before preparing said manpower dispatch order request;
transmitting said request for quotation to a plurality of terminals connected to said manpower dispatch order request means through a network, said plurality of terminals including said predetermined terminal;
receiving quotation data from said plurality of terminals;
selecting one piece of said quotation data received from said plurality of terminals; and
transmitting said manpower dispatch order request to said predetermined terminal which transmitted said selected piece of said quotation data.

7. The inspection schedule management support system as claimed in claim 1, wherein when (inspection for) part replacement is required as an inspection type, said basic data includes identification information on a replacement part;
wherein for said each device to be inspected, when (inspection for) part replacement is required as an inspection type, said inspection schedule data includes identification information on a replacement part; and
wherein said inspection schedule management support system further comprises:
parts order request means for, for each device to be inspected indicated by said inspection schedule data of said plant equipment stored in said inspection schedule database, when (inspection for) part replacement is required as an inspection type of the device, preparing a parts order request for supplying a part specified by said identification information by an estimated inspection start date of the device, and transmitting said parts order request to a predetermined terminal connected to said parts order request means through a network.

8. The inspection schedule management support system as claimed in claim 7, wherein when said inspection schedule data of said plant equipment stored in said inspection schedule database has been modified, said parts order request means determines, for each device to be inspected indicated by said modified inspection schedule data, whether it is necessary to change contents of an order request, and if it is determined that it is necessary to change said contents, said parts order request means prepares an order contents change request for said parts order request and transmits it to said predetermined terminal.

9. The inspection schedule management support system as claimed in claim 7, wherein said parts order request means performs steps of:
preparing a request for quotation before preparing said parts order request;
transmitting said request for quotation to a plurality of terminals connected to said parts order request means through a network, said plurality of terminals including said predetermined terminal;
receiving quotation data from said plurality of terminals;
selecting one piece of said quotation data received from said plurality of terminals; and
transmitting said parts order request to said predetermined terminal which transmitted said selected piece of said quotation data.

10. The inspection schedule management support system as claimed in claim 8, wherein said parts order request means performs steps of:
preparing a request for quotation before preparing said parts order request;
transmitting said request for quotation to a plurality of terminals connected to said parts order request means through a network, said plurality of terminals including said predetermined terminal;
receiving quotation data from said plurality of terminals;
selecting one piece of said quotation data received from said plurality of terminals; and
transmitting said parts order request to said predetermined terminal which transmitted said selected piece of said quotation data.

11. A computer-readable program for providing support for managing an inspection schedule for plant equipment, said program being read and executed by a computer in such a way that on said computer, said program implements:
an inspection schedule database for storing inspection schedule data of said plant equipment, said inspection schedule data including, for each device to be inspected, an estimated inspection start date, an estimated inspection end date, an inspection type, and the number of persons required for inspection;
a basic database for storing one or more pieces of basic data including, for each device constituting said plant equipment, an inspection type and the number of days required for a predetermined number of persons to complete an inspection of said inspection type;
inspection schedule display means for causing a terminal to display an inspection schedule of said plant equipment indicated by said inspection schedule data stored in said inspection schedule database, said terminal being connected to said inspection schedule display means through a network;
instruction accepting means for accepting from an operator an inspection schedule preparation instruction including, for said plant equipment, an inspection start date, specification of each device to be inspected, an inspection sequence number of each specified device to be inspected, an inspection type of each specified device to be inspected, and the number of persons assigned to an inspection of said inspection type of each specified device to be inspected; and
inspection schedule preparation means for calculating the estimated number of days required for said inspection of said each device to be inspected based on said inspection type of said each device to be inspected and said number of persons assigned to said inspection and basic data of said each device to be inspected, and preparing inspection schedule data of said plant equipment based on a result of said calculation and said inspection start date and said inspection sequence number of said each device to be inspected for said plant equipment, wherein said inspection type, said number of persons, said inspection start date, and said inspection sequence number are included in said inspection schedule preparation instruction accepted by said instruction accepting means.

12. An inspection schedule management support method for providing support for managing an inspection schedule for plant equipment, said method comprising:
an instruction accepting step of accepting from an operator an inspection schedule preparation instruction including, for said plant equipment, an inspection start date, specification of each device to be inspected, an inspection sequence number of each specified device to be inspected, an inspection type of each specified device to be inspected, and the number of persons assigned to an inspection of said inspection type of each specified device to be inspected;
an inspection schedule preparation step of calculating the estimated number of days required for said inspection of said each device to be inspected based on said inspection type of said each device to be inspected and said number of persons assigned to said inspection and a basic database, preparing inspection schedule data of said plant equipment based on a result of said calculation and said inspection start date and said inspection sequence number of said each device to be inspected for said plant equipment, and storing said inspection schedule data in an inspection schedule database, wherein said inspection type, said number of persons, said inspection start date, and said inspection sequence number are included in said inspection schedule preparation instruction, wherein said basic database stores one or more pieces of basic data including, for each device constituting plant equipment, an inspection type and the number of days required for a predetermined number of persons to complete an inspection of said inspection type, and wherein inspection schedule data of plant equipment includes, for each device to be inspected, an inspection start date, an inspection end date, an inspection type, and the number of persons required for inspection; and
a display step of causing a terminal to display an inspection schedule of said plant equipment indicated by said inspection schedule data stored in said inspection schedule database, said terminal being connected to a network.
